(19) United States
(12) Patent Application Publication
(10) Pub. No.: US 2003/0061330 A1
(43) Pub. Date: Mar. 27, 2003

(54) Web-based collaborative project and process management solution

(76) Inventors: Lynn A. Frisco, Lawrenceville, GA (US); James W. Grissom, Winston-Salem, NC (US); Matthew B. Henry, Roswell, GA (US); James P. McDonnell, Alpharetta, GA (US); Michael J. Miedona, Alpharetta, GA (US); James K. Peters, Arlington, TX (US); Allison B. Shue, Cumming, GA (US); Jeffrey Joseph Shue, Cumming, GA (US); Larry S. Shutzberg, Duluth, GA (US); Richard A. Wheadon, Lawrenceville, GA (US); William L. Wheaton, Decatur, GA (US); Alec Black, Marietta, GA (US)

Correspondence Address: Vaibhav P. Kadaba, KILPATRICK STOCKTON LLP, Suite 2800, 1100 Peachtree Street, Atlanta, GA, 30309-4530, US

(21) Appl. No.: 09/966,710

(22) Filed: Sep. 28, 2001

Related U.S. Application Data
(60) Provisional application No. 60/236,642, filed on Sep. 29, 2000.

(51) Int. Cl. G06F 15/173

(52) U.S. Cl. 709/223

(57) ABSTRACT

The present invention provides a project and process management tool for managing projects requiring collaboration among multiple parties. The present invention allows each participating organization to define their own process for managing projects, including the nomenclature they wish to use and the project attributes they wish to track. The system provides merging and cross referencing of process and project attributes with each participating organization. This feature allows participating organizations to view similar activities across various projects, providing effective process management. The system provides web-based notification functionalities, including email, and security measures which are critical to such large projects. Other features of the project management tool include searching of the system database and the ability to manage project activities outsourced to third parties.

This application claims priority to United States Provisional Application No. 60/236,642 filed on Sep. 29, 2000.

### FIELD OF THE INVENTION

Many industries that engage in collaborative project management involve projects requiring complex coordination of critical activities between multiple organizations, across various functional areas. These extremely dynamic projects range in complexity, number of activities and breadth of functional areas involved. The inputs, speed, expertise, and location of the various parties involved preclude a centrally located group from handling all aspects of these projects from start to finish.

The present invention relates generally to an automated tool for managing activities related to a project, and more particularly, to a system for managing complex coordination efforts for projects involving multiple tasks and organizations performing those tasks.

### BACKGROUND

Many industries spawn projects that require coordination across many functional areas within customer and vendor organizations, as well as organizations providing third party services. These projects can be found in areas such as consumer promotions, new product development, capital project management, mergers, acquisitions, joint ventures, and dozens of other areas requiring information sharing, milestone or critical path tracking, and other collaborative functions. Corporate functional areas often include:

Primary project responsibility (promotions, marketing, engineering, purchasing, financial, legal, etc.)

Sales

Marketing/Brand Management

Product Planning/Supply Chain

Legal/Regulatory

Artwork/Graphics

Packaging/Industrial Engineering

Customer Service

Purchasing/Receiving

Inventory Control

Manufacturing/Assembling

Quality

Shipping/Distribution

Financial

Invariably, these functional areas are not centrally located, creating communication and timing challenges when efforts need to be coordinated. Compounding this challenge is the fact that most internal business systems are focused on transactions and do not provide support for a multitude of critical activities that go into many of these collaborative projects. Furthermore, these projects are often non-recurring, stand-alone projects, requiring many levels of approval and sign-off across various functional levels to ensure compliance with company and governmental policies and procedures as well as corporate financial objectives, making coordination of efforts even more challenging.

In many cases, critical sign-off documents must be forwarded back and forth between multiple parties, either in hard copy or email, for appropriate approvals. Project documents generated in multiple formats (such as Word, Excel, CAD, PDF, etc.) are typically scattered and duplicated throughout each involved organization. Frequent time delays are created on projects when documents are misplaced or not acted upon in the necessary timeframe. Other challenges include ensuring that all involved parties have the most current document versions. Difficulties may arise when the wrong version of a document is used, possibly resulting in project delays, increased costs due to rework, and potentially large fines.

Most current project management solutions are built from a single organization's perspective, focused primarily on internal project activities that are to be tracked. These solutions do not facilitate timely coordination and planning across functional areas of the customer, vendor, and third party service providers. Additionally, appropriate security is not present within these systems that would allow the use of existing project management systems with partner organizations, as confidential information may be at risk. This results in significant redundancies and inefficiencies as project information is traded between organizations. Problems arise because no comprehensive view of multi-organization projects is possible without time-consuming, error-prone synchronization of project information between each involved organization. These problems are intensified when project activities for one organization are dependent on the completion of activities by another organization.

Many organizations use software programs such as Microsoft Access or Microsoft Project to create project databases. In many cases, these types of project management solutions consist of Excel and Word documents on a shared network drive, combined with email to disparate parties. These approaches require a high level of data maintenance and close coordination to ensure the accuracy of project information. Likewise, project databases are not easily accessible for all internal parties if the data resides on a PC or LAN specific to a particular functional area. In addition, these approaches do not allow for the attachment and storage of related project documents, which must be routinely emailed to all involved parties, internal and external. Most importantly, these types of solutions do not readily allow for multi-organization project management.

With all of these project management challenges, existing solutions frequently necessitate dedicated central administration to maintain the status of each project via email, phone, or fax, for periodic distribution to all involved parties. Existing project management tools do not provide for centralized management of multiple related tasks across corporate functional areas within the overall project. Such deficiencies in existing project management tools make it difficult to track the timeliness of critical tasks within the project. Corporate functional areas responsible for individual tasks must prioritize their activities without knowledge of progress of other time critical tasks being performed by other functional areas. The result is inefficiencies in prioritization of tasks within corporate functional areas, with certain tasks being completed sooner than required or delay in time critical tasks of one functional area causing unexpected delays and duplicative efforts for other functional areas. Though a few web-based, collaborative project management solutions have recently become available, these solutions fall far short in addressing the complications found in collaborative, multi-organization project management. Though functional in pure project management disciplines, these solutions focus on individual projects without regard for differences in organizational processes, nomenclature, and the unique project management requirements of each participating organization. Furthermore, none of today's project management solutions address the more elusive challenge of organizational process management, particularly those involving multiple organizations.

As described above, many inefficient and ineffective project management tools have evolved to handle complexities in coordination of efforts/processes across multiple organizations. These tools are limited, requiring each involved organization to use their own project management solution to address various pieces of each project. There is currently no single solution that can meet the project management needs for all parties. Likewise, an efficient method for managing similar activities across all projects (i.e. process management) does not exist for most organizations, especially when multiple organizations are involved with these projects.

### SUMMARY OF THE INVENTION

BlueCuda™ is a web-based collaborative project and process management solution targeted for projects requiring a high level of collaboration among both internal and external parties. The present invention was developed with the focus of helping an entire industry or multiple industries manage complex projects involving multiple activities with critical dependencies across customer, vendor, and third party organizations. The invention functions using an Application Service Provider (ASP) model and is therefore neutrally positioned outside of participating organizations.

A principal function of this solution is collaborative and coordinated project management across all participating organizations for both internal & external parties. Unlike other collaborative project management solutions, BlueCuda™ allows each participating organization to define their own process for managing projects, including the nomenclature they wish to use and the project attributes they wish to track. Key project attributes include project activities/milestones as well as critical project information used for management reporting.

The system provides easy project set-up and timeline creation via unique partnership templates, which can be setup for each type of project between partner organizations. These unique partnership templates merge each organization's processes and project attributes with each of their partners, while maintaining cross-references back into the same for each participating organization. This distinctive merging and cross-referencing enables BlueCuda™ to provide critical process management capabilities as organizations can view similar processes across all company projects, regardless of the partner organization responsible for each project. With BlueCuda™, proactive process management is actually possible despite the fact that each partner organization may have a different project management approach, with unique project attributes and their own company nomenclature.

In providing multi-organization project and process management functionality, BlueCuda™ also provides the ability for third party organizations to collaborate on outsourced project activities. Also, organizations centrally involved in the project may more easily track the progress of such third party outsourced activities. Additionally, incorporated into BlueCuda™ is the ability to attach all related project documents, regardless of document format, both at the overall project and individual project activity or task level. This feature eliminates the risk of disseminating non-current versions of documents and duplicative information. The present invention also provides easy access to all relevant project information.

With respect to communication among all parties involved with multi-organization projects, BlueCuda™ incorporates email notification. However, unlike typical email notification functionality, the system encapsulates and organizes all notifications into an easy-to-understand, personalized newsletter. Emailed newsletters contain groupings, including Late Activities, Advanced Notifications, New Projects/Activities, and Changed Projects/Activities. Each notification in these newsletters also contains a “hot link” back into BlueCuda™ for easy access to relevant information. The newsletter may be distributed once daily, or at any desired interval. To address high priority issues, the system also incorporates a “Notify Now” functionality, which allows for urgent information to be emailed immediately to all appropriate parties.

The present invention also incorporates many security features including private activities, private third parties, viewable users, viewable partners, and user selection for maintenance and notification privileges across all projects and project activities. This feature protects confidential information by only allowing access to information indicated as confidential to users with the proper security clearance. The system also incorporates document locking, which facilitates orderly maintenance of projects and project activities across all participating organizations, and eliminates the risk of distribution of inaccurate documents/information.

Also incorporated into the present invention are extensive searching capabilities that allow users to easily find desired projects and project activities. These searches extend into readable file attachments, including Word, Excel, and PDF documents. The system also allows for recursive searching, which lets users continuously search the results of their previous search.

The present invention also offers configurable web-based reporting whereby each organization can customize the method, format and delivery timetable for project status reporting. Incorporated into this feature is the ability for organizations to use their global project attributes as sort and filter criteria for these reports. This feature also gives organizations the ability to download all project information into their own project database for extended, integrated, and customized project management applications.

The ability to manage all types of projects using a single tool independent of the partner selected for each project is of significant value. The present invention makes this “one-stop shopping” approach for project management possible since the system can be configured to address unique project management requirements for each participating organization.

The present invention provides the ability to manage similar project activities involving a plurality of companies using a single tool. This is possible because the system allows for unique company nomenclature for all participating organizations.

Another feature of the present invention is the ability to define a project activity as shared, making it accessible to both the customer and vendor, or private, making it only accessible to the responsible organization. This feature, when combined with the ability to attach project documents, allows for confidential information to be tracked, or simply allows organizations to track project activities that are only of interest to the responsible organization. Accordingly, private project activities are only accessible to users on one side of the partnership for the project.

Another feature of the present invention tracks the status of each project activity. Project activities can be Open, Held, Canceled, or Completed. Activity status is automatically changed from Open to Completed when an actual completion date is entered, indicating completion of that activity or task. Likewise, status is changed from Completed to Open if this date is removed. Additionally, authorized users have the ability to place project activities on hold, release previously held project activities, cancel project activities, or uncancel previously canceled project activities.

Based on the status of all project activities, the system may also track project status for both the customer and vendor. This allows one organization to consider a project complete while the other organization continues to work on remaining private project activities (specific to that organization) that may still be open.

Yet another feature of the present invention allows for the attachment of files (documents) to any project or project activity. The system thus becomes a central repository for all project documents of any type, regardless if the customer, vendor, or third party service provider created them. Individuals users can be provided or denied access to certain documents. With this feature, real-time file accessibility from remote sites is dramatically enhanced. This also eliminates the non-value-added effort on telephones, faxes, and email tracking of correct document versions. Likewise, the system may be used to store electronic files for past projects, which may be beneficial to one or more involved parties, where all those accessing the system can locate the files.

At any time during project, project activities may be assigned to a third party service provider, though responsibility typically remains with the responsible organization for all project activities (customer or vendor). Several features of the present invention facilitate collaboration and management with third parties. Third party system users are automatically included for notification regarding their respective assigned project activities. Accordingly, they receive email notifications containing secured, direct links back into their assigned project activities. Critical documents such as product specifications and purchase orders can therefore be shared with third party users as activity file attachments. In addition, the system provides views of all outsourced project activities listed by name of third party for ease of management. Third party users can also access the system and view all project activities assigned to them from all participating organization, in order, by due date, along with all related file attachments.

For privacy reasons, third party assignments are only accessible to organizations responsible for those project activities. This allows organizations to collaborate with third party service providers in a confidential manner. Accordingly, organizations only have access to third party providers for which a third party relationship has been established. This allows third party providers to have relationships with multiple organizations while respecting privacy desires for each organization. Also, unlike other system users, third party users only have accessibility to project activities assigned to them. Third parties are only able to retrieve and store activity documents as well as maintain activity notes. Third party users have no access to global project information and cannot affect the status according to the system of a project activity that is assigned to them.

According to the present invention, each organization involved in the overall project begins by defining a list of master activities they wish to track. The present invention allows each organization to use its desired nomenclature for their system views, reporting, and other functionality. Organizations also designate normal workdays for each master activity, which along with designated company holidays, facilitates planned completion date calculations by the system during project creation and maintenance. Along with master activities, each organization also defines global project attributes they wish to track on all projects, across all partnerships. Global project attributes are defined either as selectable fields with valid selections or as enterable fields. This allows each organization to capture desired project information for all of their projects, regardless of partner.

An unlimited number of customizable partnership templates can be created between customer and vendor organizations, which contain business rules that facilitate project creation. Each partnership template identifies default values for project attributes that are to be tracked, including but not limited to:

Project contacts (customer and vendor users responsible for projects)

Global project attributes (default values, optional)

Maintenance users (users/groups allowed to maintain projects)

Notification users (users/groups to receive notification about projects)

Project file attachments (i.e. standard forms, optional)

Each partnership template also identifies critical project activities for tracking and measurement, as well as several attributes for each of these project activities, including, but not limited to:

Activity type (shared or private)

Responsible organization (customer or vendor)

Responsible user (user typically responsible for project activity)

Anchor activity (preceding project activity, if applicable)

+Days (approximately days for completion after anchor activity)

Workdays (days of the week worked)

Advanced notification days (days to be notified before planned completion date if open, optional)

third party organization (if project activity is to be outsourced, optional)

third party user (if project activity is to be outsourced, optional)

Maintenance users (users/groups allowed to maintain project activity)

Notification users (users/groups to receive notification about project activity)

Activity file attachments (optional)

Each project activity on a partnership template is cross-referenced back to each organization's master activity list, allowing organizations to use their own activity nomenclature on system views and reports. Private project activities are only cross-referenced back to the responsible organization's master activity list.

Organizations can have as many partnership templates as desired to account for the different types of projects between organizations. This is very useful as different types of projects require different project activities and often have different project and project activity attributes.

The system uses partnership templates to create projects quickly and easily. Both customer lead users and vendor lead users can create projects. Once a partner is selected, all partnership templates with that partner appear for selection. Once a partnership template is selected, business rules take over and provide much of the input required for creating a project. Appropriate project-specific values are entered, documents are attached (optionally), and project activity planning then begins. Each newly created project begins with the project activities designated on the chosen partnership template. Drop down menus, calendar icons, and other useful mechanisms are incorporated to make data entry easy for the user. Project activities can be added or canceled as desired. Any partnership template value created by default may be altered for the project being created. Critical target completion date(s) are entered for certain project activities and the system calculates resulting planned completion dates for all remaining project activities.

Once all project information is entered, the project is created and all appropriate users are notified via email of the new project and project activities that were created.

The system provides the ability to create special project activities that were not originally included in the partnership template used to create the project. Additional project activities can be created at any time during the life of a project. These activities would be treated as other activities created at the commencement of the project.

Once project activities are defined and critical/desired completion dates are established for at least one project activity, the system may use “smart” logic to calculate planned completion dates for all remaining project activities. The present invention performs date calculations for project activities by anchoring project activities. By anchoring project activities, the system is able to calculate completion dates for certain activities that are related to or dependent on the anchored activities. Using these activity anchors, the system can calculate backwards or forwards in determining planned completion dates for all remaining project activities. During date calculations, the system skips any activity with a predetermined planned completion date (or “pinned” date). The system uses activity workdays, holidays, activity anchors, and +days to determine planned completion dates for all “unpinned” project activities. If more than one project activity is anchored to another project activity, the system determines an appropriate date that respects all anchored activities. If certain activities for a given project take more or less days than normal, users can override the +days for those project activities, which facilitates more accurate date calculations.

As planned completion dates are entered (“pinned”) into the system, users are warned when these dates fall on a non-workday or holiday. Users are also warned when planned or actual completion dates which are entered fall in the past or when activity +days are shorter than usual. Authorized users may revisit any project to change and recalculate planned completion dates during the life of that project.

The system allows each project and each project activity to have designated users and/or user groups that can maintain information for that project or project activity. This allows organizations to have the user security they desire, even if that security is different for each project and project activity. Once appropriate designees are setup in partnership templates, maintenance users are automatically created for each project and project activity during project creation and can then be altered at any time. Project contacts are automatically given maintenance authority to their projects and all associated project activities. Similarly, responsible users are automatically given maintenance authority to their assigned project activities.

During project creation, the system allows users to save information in draft for a project being created. This allows users to bypass project validations and save partial project information. Draft projects can then be revisited where users can finish project creation with complete project information. This feature is very useful when complete project information is not yet known but users desire to begin the project creation process.

Authorized maintenance users can easily update project activities. The system incorporates timesaving mechanisms for updating project activities quickly, including the use of “Yesterday” and “Today” buttons for entering actual completion dates.

The system provides the ability to quickly update activity completion dates using “My Views,” which show only projects or project activities belonging to the user. This feature allows a user to quickly update several project activities at once for which he is the responsible user or the project contact.

The system allows each project and each project activity to have designated users and/or user groups that are to receive email notification for that project or project activity. This allows organizations to establish communication rules they desire, even if communication rules are different for each project and project activity. Once appropriate designees are setup in partnership templates, notification users are automatically created for each project and project activity during project creation and can then be altered at any time.

The system allows each project activity to generate advanced notification whereby designated users and/or user groups receive email notification of an upcoming due date if that project activity is not completed (and identified as completed within the system) by a specified number of workdays before its planned completion date. Advanced notification days can be different for each project activity and can also be different for customer and vendor users.

The system provides for automatic email notification to selected users for each project and project activity. Rather than inundating users with email notifications throughout the day, the system collects and summarizes (or encapsulates) all email notifications for all users and emails these notifications to each user in the form of a newsletter on a scheduled basis throughout the day (as often as configured). Emailed newsletters contain groupings, including Late Activities, Advanced Notifications, New Projects/Activities, and Changed Projects/Activities. Notification users for each project and project activity are used to determine what to include on each user's newsletter.

To address high priority changes, the system also incorporates “Notify Now” functionality, which allows for urgent information to be emailed immediately to all appropriate parties. Unlike the daily newsletter, users can determine who to send a “Notify Now” email to, including all notification users as well as users outside of the system. Changes sent using the “Notify Now” feature are also included in the next daily newsletter for all notification users if desired.

For all system users, each email contains a “hot link” for every project and project activity, allowing quick and easy access into the system, directly to the project or project activity selected.

The system provides a feature for users to request an instant newsletter rather than waiting for the next scheduled newsletter. The system then creates a newsletter for that user and allows the user to view the results on-line or be sent in an email, similar to the daily newsletter. Changes included in the instant newslettering feature are also included in the next daily newsletter for that user.

The system provides several options for viewing projects and project activities. Users can see all projects and project activities for their entire organization or focus on just their projects and project activities. These multiple views provide a quick means to understand workload by planned completion date, activity, or responsible user. Likewise, organizations can view activity backlogs across all projects, including all late activities. Pro-active process improvement as well as tactical decision support and overall project management may be greatly facilitated with this capability.

For each view, the system provides the option to only show project activities with specific statuses. Users can also choose to group projects and project activities by partner.

The system incorporates extensive searching capabilities that allow users to easily find desired projects and project activities. These searches extend into readable file attachments, including Word, Excel, and PDF documents. The system also allows for recursive searching, which lets users continuously search the results of their previous search.

The system offers configurable web-based reporting whereby each organization can customize the method, format and delivery timetable for project status reporting. Incorporated into this feature is the ability for organizations to use their global project attributes as sort and filter criteria for these reports. This feature also gives organizations the ability to download all project information into their own project database for extended, integrated, and customized project management applications.

The system gives each organization the ability to track private project activities. This feature enables confidential information to be tracked as well as project activities that are only of interest to the responsible organization. Only designated users from the organization responsible for a private project activity can view that activity.

Due to the nature of some industries where vendor users are located onsite with the customer (or vice versa), unique security issues arise. Confidential information must be maintained despite access to the system by vendor users. Accordingly, the system allows optional viewable partner configuration for those users needing this extra measure of security.

To address the fact that only certain customer and vendor users and user groups are involved with each partnership, the system allows viewable user and user group configuration for each partnership. This feature allows users to only see the users and user groups that serve that partnership, when making a selection in any user field.

The frequent need to outsource certain project activities to third party service providers introduces issues requiring extra security measures. At times, third party usage may be confidential in nature. Accordingly, the system allows users to only see third parties having a relationship with their organization. Also, third party assignments are only accessible to responsible organizations (internal users), thus protecting the confidentiality of third party assignments. Additionally, third party users have limited access to assigned project activities, including the ability to retrieve and store activity documents as well as maintain activity notes.

The system incorporates document locking, which facilitates orderly maintenance of projects and project activities across all participating organizations. All information throughout the system is stored in documents. Any document retrieved in “edit” mode is locked when other users attempt to edit the same document. When a document is locked, other users trying to edit the same document are told the name of the user that has the document locked. The system may use a “time out” strategy to release locked documents when user inactivity is detected.

The system allows authorized users to designate customer and vendor users that can maintain each project and project activity as well as those customer and vendor users that are to receive email notifications about each project and project activity. Appropriate user selections are first made on partnership templates between organizations. Once designated, users are established on a partnership template, they are then copied into each project and project activity as that partnership template is selected during project creation. Authorized users may then alter designated customer and vendor maintenance and notification users for any project or project activity at any time.

### BRIEF DESCRIPTION OF THE DRAWINGS

FIG. 1 is a functional block diagram showing the relationships between various organizations and the system.

FIG. 2 is a screenshot showing the registration procedure within the system.

FIG. 2A is a screenshot showing the project master activity list.

FIG. 2B is a screenshot showing the project workdays.

FIG. 2C is a screenshot showing the global project attributes.

FIG. 3 is a screenshot showing a partnership template.

FIG. 4 is a screenshot showing a partnership template with activity list.

FIG. 5 is a screenshot showing a partnership template showing default values.

FIG. 5A is a screenshot showing a partnership template showing customer and vendor information.

FIG. 5B is a screenshot showing a partnership template showing default project activity values.

FIG. 5C is a screenshot showing a partnership template showing default workday values.

FIG. 5D is a screenshot showing a partnership template showing other default values.

FIG. 6 is a screenshot showing a partnership template showing selection of a partner and partnership template.

FIG. 7 is a screenshot showing a template for project creation.

FIG. 7A is a screenshot showing a partnership template with project information.

FIG. 7B is a screenshot showing a partnership template with project attributes.

FIG. 8 is a screenshot showing project activity information.

FIG. 9 is a screenshot showing more project activity information.

FIG. 10 is a screenshot showing notify now icon and functionality.

FIG. 11 is a screenshot showing notify now functionality.

FIG. 12 is a screenshot showing add activity functionality.

FIG. 12A is a screenshot showing add activity functionality.

FIG. 13 is a screenshot showing activity information maintenance.

FIG. 14 is a screenshot showing my projects icon and functionality.

FIG. 14A is a screenshot showing my projects functionality by project.

FIG. 14B is a screenshot showing my projects functionality by plan date.

FIG. 14C is a screenshot showing my projects functionality by activity.

FIG. 15 is a screenshot showing my activities icon and functionality.

FIG. 15A is a screenshot showing my activities fiuctionality by project.

FIG. 15B is a screenshot showing my activities functionality by plan date.

FIG. 15C is a screenshot showing my activities functionality by activity.

FIG. 16 is a screenshot showing company views icon and functionality.

FIG. 16A is a screenshot showing company views functionality by project.

FIG. 16B is a screenshot showing company views functionality by planned date/activity.

FIG. 16C is a screenshot showing company views functionality by planned date/responsibilty.

FIG. 16D is a screenshot showing company views functionality by activity/planned date.

FIG. 16E is a screenshot showing my company views functionality by activity/responsibility.

FIG. 16F is a screenshot showing my company views functionality by responsibility/plan date.

FIG. 16G is a screenshot showing my company views functionality by responsibility/activity.

FIG. 16H is a screenshot showing my company views functionality by third party.

FIG. 17 is a screenshot showing grouping options.

FIG. 18 is a screen shot showing show options.

FIG. 19 is a screen shot showing searching functionality.

FIG. 20 is a screenshot showing notification/newsletter functionality.

FIG. 20A is a screenshot showing notification/newsletter functionality.

FIG. 21 is a screenshot showing web-based reporting functionality.

FIG. 21A is a screenshot showing web-based reporting functionality.

FIG. 21B is a screenshot showing web-based reporting functionality.

FIG. 22 is a chart showing activity statuses.

FIG. 23 is a chart showing project statuses.

FIG. 24 is a chart showing user types.

FIG. 25 is a process flow diagram showing project management functionality.

FIG. 26 is a process flow diagram showing process management functionality.

### DETAILED DESCRIPTION

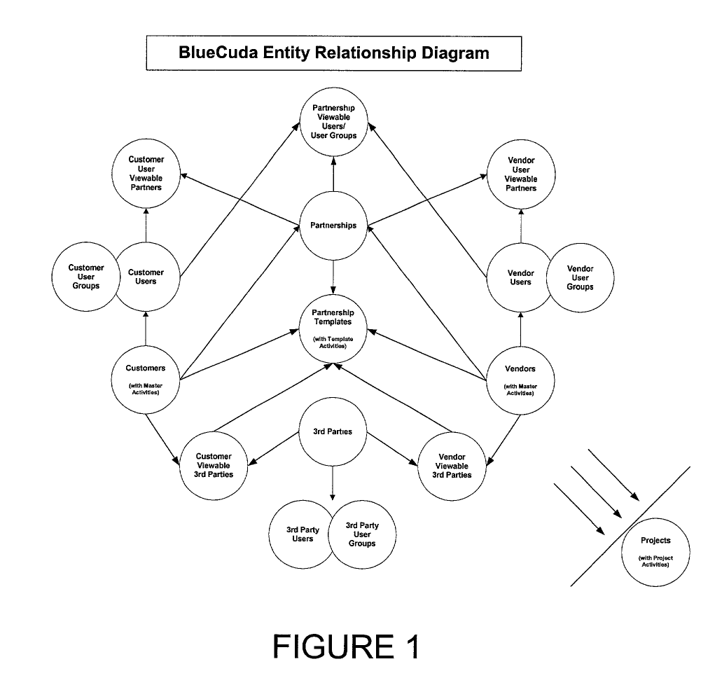

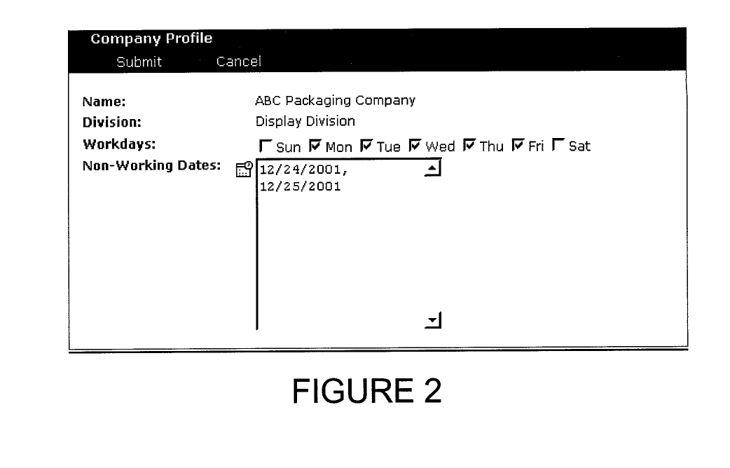

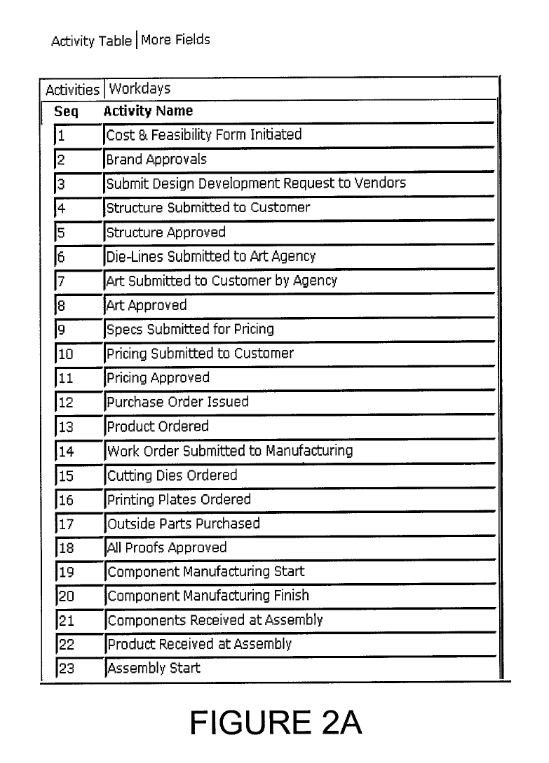

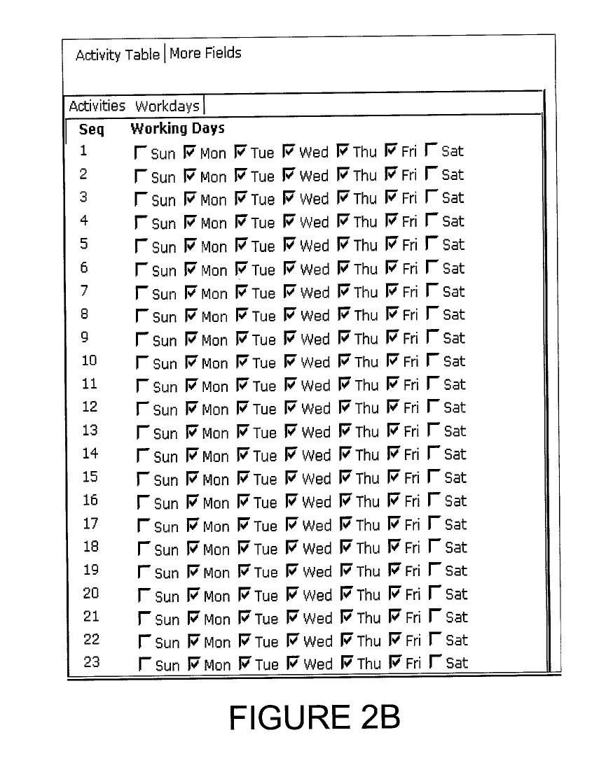

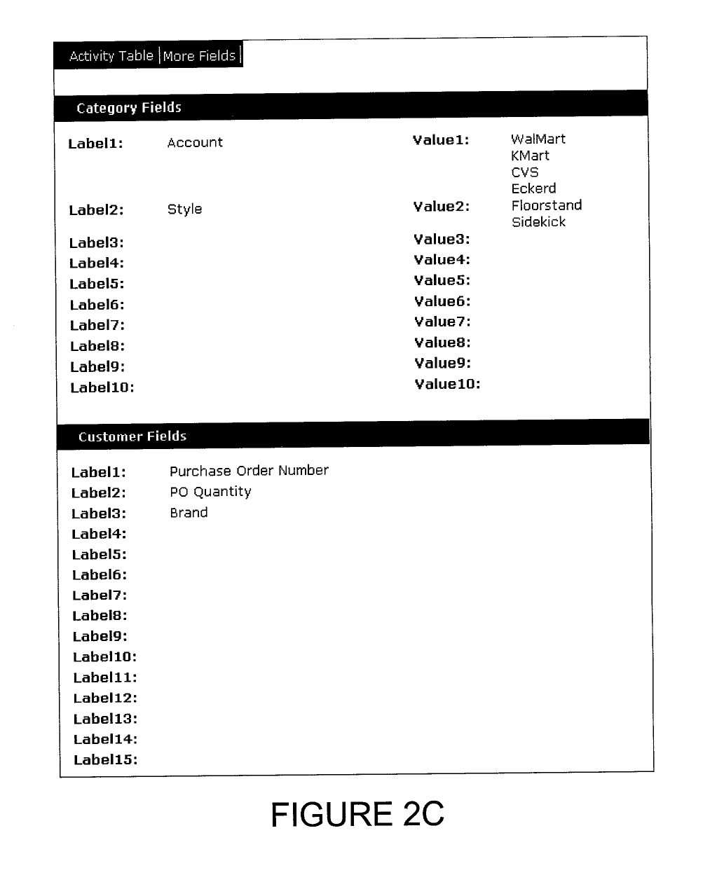

The system begins with a number of defined entities and relationships between entities, as shown in FIG. 1. All customer and vendor organizations must first be registered into the system via the system administrator. During this process, basic organizational information is captured, as shown in FIG. 2. Once organizations are setup in the system, a lead user for each organization or the system administrator then establishes baseline organizational information that will be used throughout the system. As shown in FIG. 2, this information includes:

Company non-workdays/holidays

Master activities to be tracked by the organization across all projects, using desired company nomenclature

Normal workdays for each master activity

Global project attributes to be tracked by the company across all projects, defined either as selectable fields with valid selections or as enterable fields

Once a customer or vendor is registered into the system, the system administrator can then register users into the system as a member of one of these organizations. Each user is assigned a unique user ID and a temporary password that can be changed by the user at any time. User information is also captured including the user's email address and user preferences for system email notification. The system administrator can also establish an unlimited number of users groups, each consisting of several registered users within the company or organization. Established customer and vendor users and user groups can then be selected in various customer and vendor user fields throughout the system.

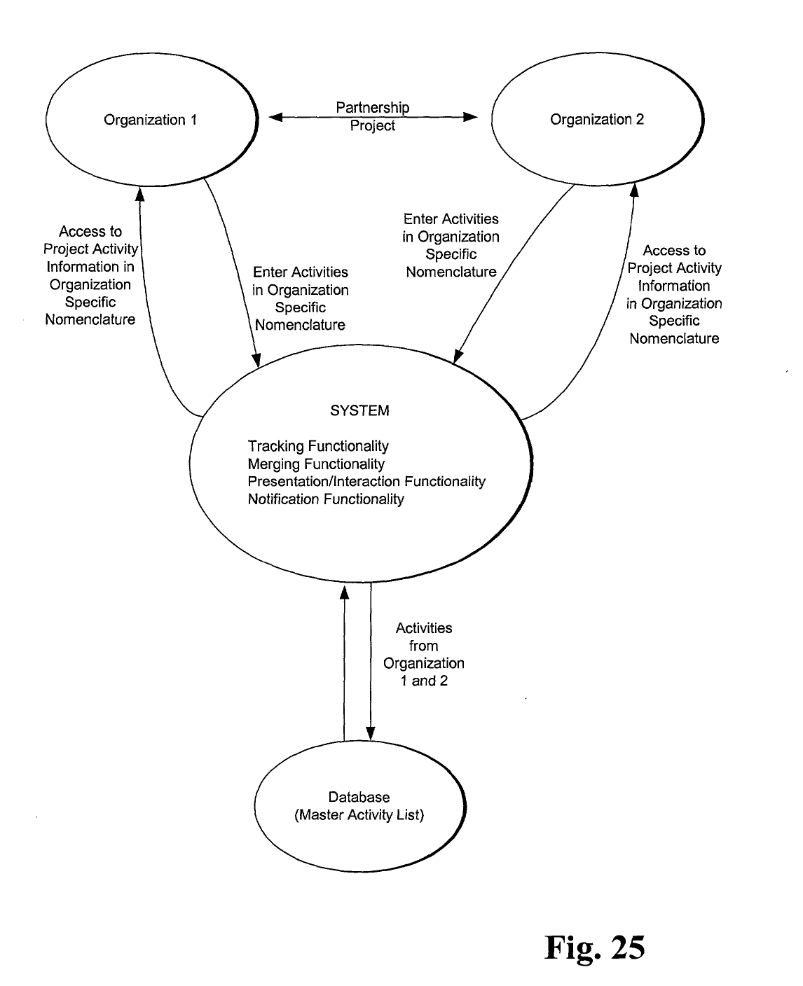

Once customer and vendor organizations are setup in the system, the system administrator then sets up partnerships between any customer and vendor organizations wishing to collaborate on projects using the system. A unique partnership is established for each customer/vendor combination. This allows each partnership to establish unique business rules, processes, and project attributes they wish to track for their partnership. Each partnership also establishes the desired terminology for global project attributes, including which project attributes will be accessible for each organization and what nomenclature will be used to identify these project attributes. This functionality provides the ability for each company to capture and report on project attributes they desire while at the same time merging the capturing of these project attributes for each company into a shared project management process, as shown in FIG. 25.

As each organization inputs their project attributes and activities in its own organization specific nomenclature, this information is stored in the system database in separate records. The attributes and activities of each organization are linked to a master list of activities in the project database, as shown in FIG. 25. This allows the system to track each activity and allows organizations to view and access information in its organization specific nomenclature. Reporting by the system of activity progress is also accomplished in organization specific nomenclature. In the event an organization changes the name of an activity, the name change is linked to the master activity list and changed globally within the system.

Due to the nature of some industries where vendor users are located onsite with the customer (or vice versa), unique security issues may arise. Confidential information must be maintained despite access to the system by vendor users. Accordingly, the system allows optional viewable partner configuration for those users needing this extra measure of security.

For each user having this extra security measure, the system administrator sets up a user and the partnerships for that user's company that can be viewed. Only established partnerships can be used to designate viewable partner organizations. Once setup, identified customer users can only view activity for designated vendors and identified vendor users can only view activity for designated customers.

To address the fact that only certain customer and vendor users and user groups are involved with each partnership, the system allows viewable user and user group configuration for each partnership. This feature allows users to only see the users and user groups that serve that partnership, when making a selection in any user field.

The system administrator sets up the customer and vendor users and user groups that can be viewed by both organizations. Only established users and user groups for a partnership's customer and vendor can be designated as viewable by that partnership.

All third party organizations must first be registered into the system via the system administrator. During this process, basic organization information is captured.

Once a third party is registered into the system, the system administrator can then register users into the system as a member of the third party organization. Each user is assigned a unique user ID and a temporary password that can be changed by the user at any time. User information is also captured including the user's email address and user preferences for system email notification. The system administrator can also establish an unlimited number of users groups, each consisting of several registered users within the company. Established third party users and usergroups can then be selected in various third party user fields throughout the system.

The frequent need to outsource certain project activities to third party service providers introduces issues which may require extra security measures. At times, third party usage may be confidential in nature. Accordingly, the system allows users to only see third parties having a relationship with their organization. Also, third party assignments are only accessible to responsible organizations (internal users), thus protecting the confidentiality of third party assignments. Additionally, third party users have limited access to assigned activities, including the ability to retrieve and store activity documents as well as maintain activity notes.

The system administrator sets up the third parties that can be viewed by each customer and vendor organization. Only established third parties can be designated as viewable by a customer or vendor organization.

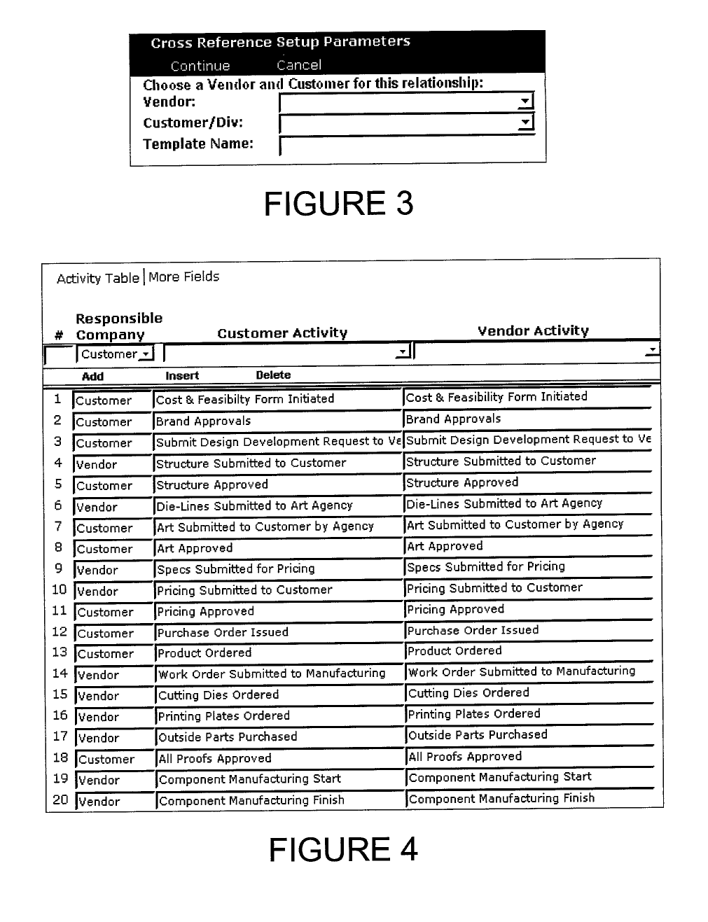

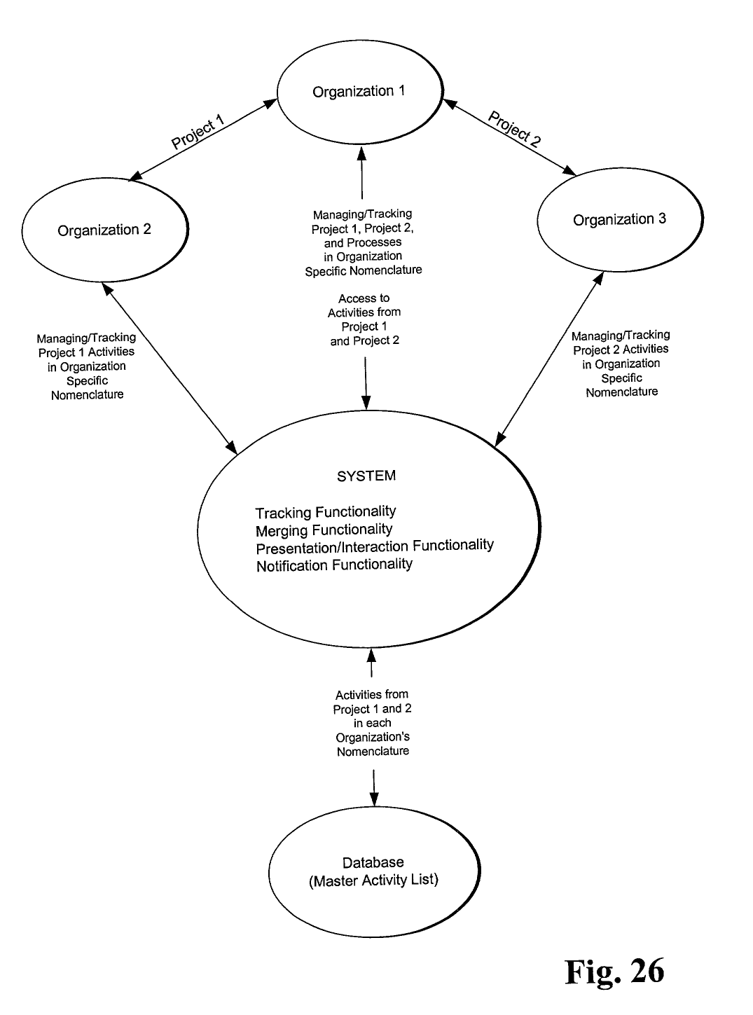

An unlimited number of customizable partnership templates can be created for each customer/vendor partnership. Partnership templates can only be created for existing partnerships. Once a partnership is created, there are two steps in creating partnership templates, one for the system administrator and one for an authorized lead customer or vendor user (FIGS. 3 and 4). First, the system administrator establishes those project activities that the partnership wishes to track on projects that will be created using the partnership template being established. The system administrator then matches each of these project activities back to the corresponding master activity list for both the customer and vendor organizations. This master activity matching is critical in providing the ability for each company to track and report on project activities they desire while at the same time merging the tracking of these project activities for each company into a shared project management process. This matching also enables a global view of similar activities across all company projects for each organization, regardless of the partner organization for each project, as shown in FIG. 26.

The system administrator also establishes whether each project activity is shared or private as well as the responsible organization for each project activity. These factors determine activity accessibility (private project activities will only be visible to one organization) and which responsible users and third parties can be assigned to each project activity (only those for the responsible organization).

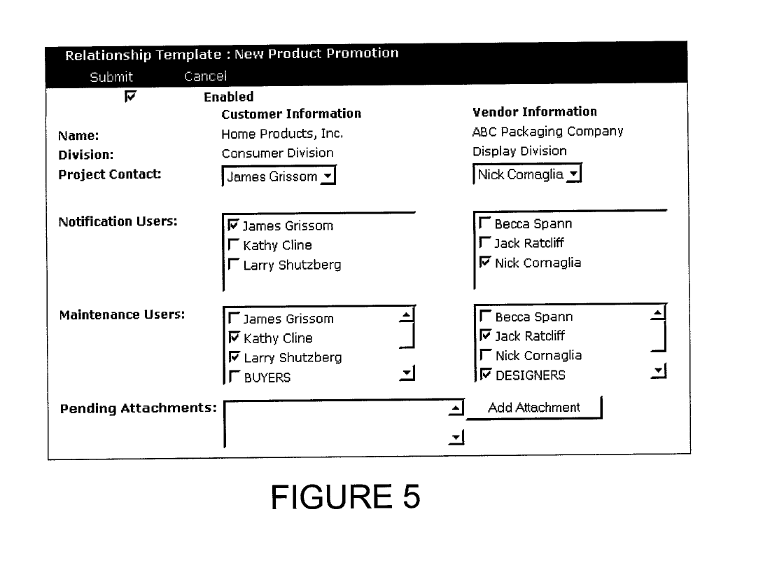

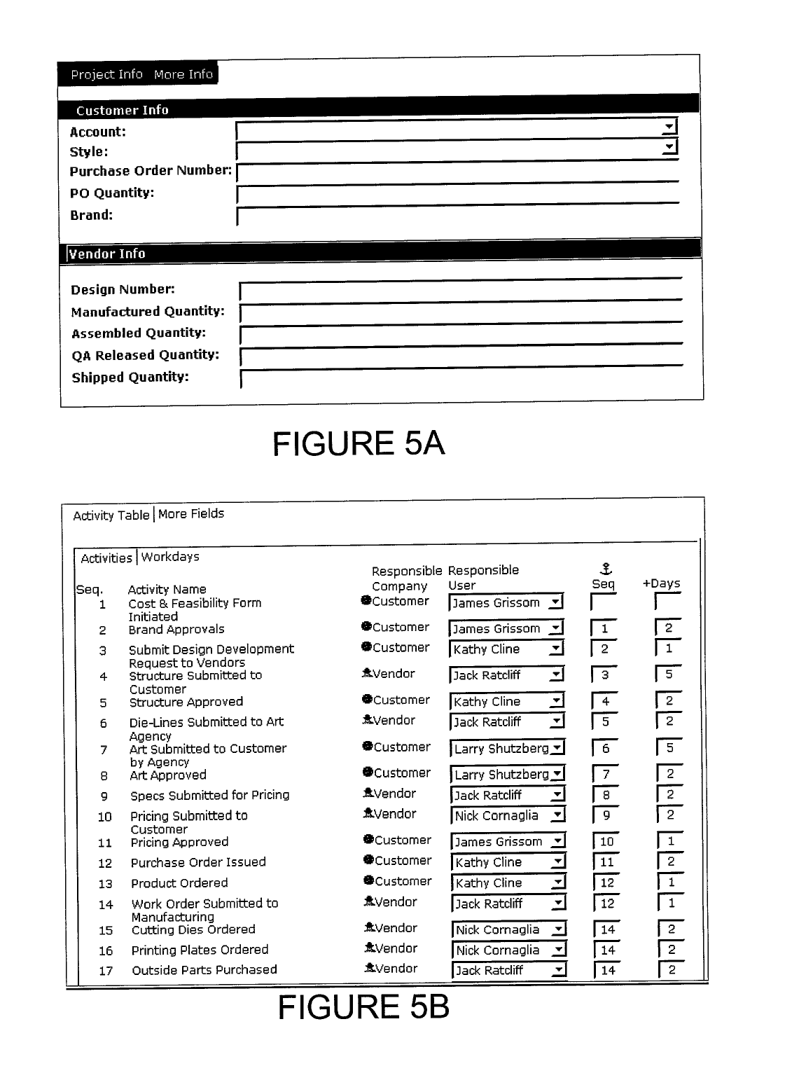

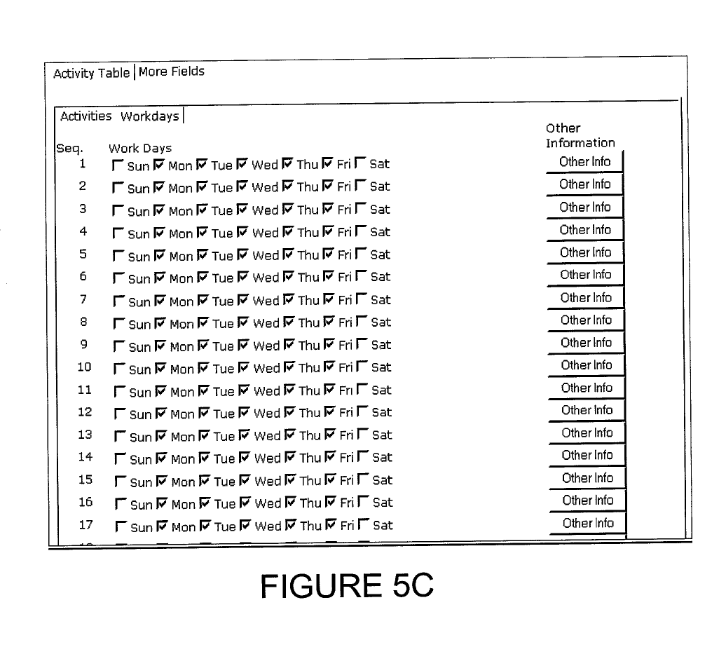

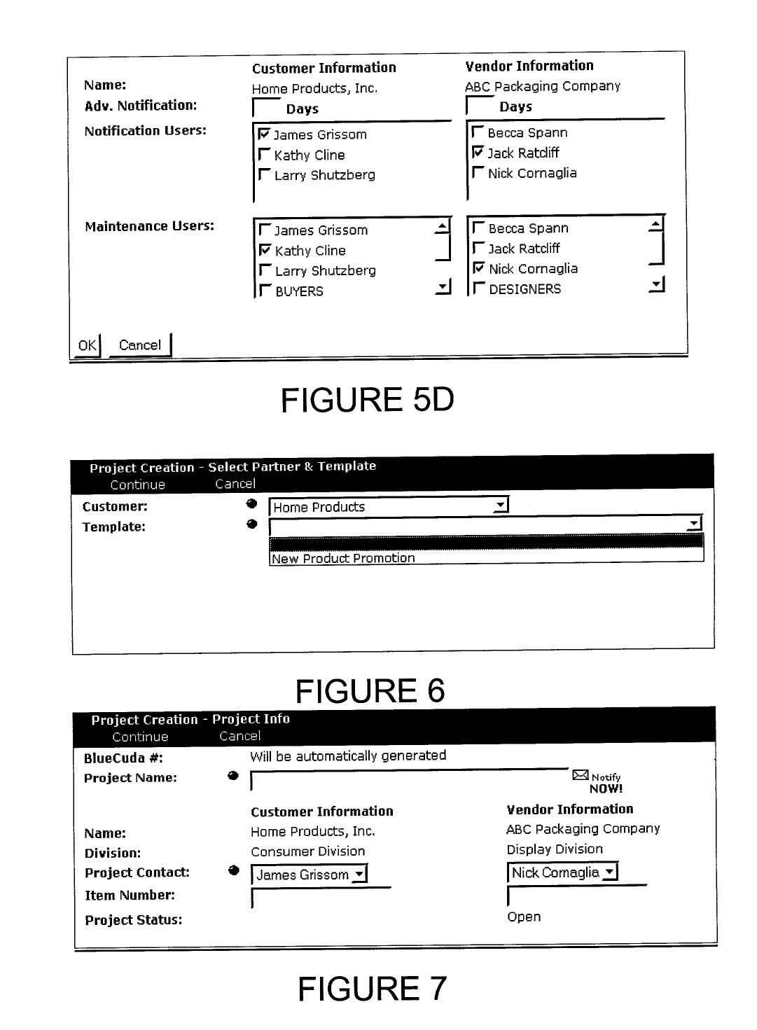

Once the system administrator establishes a partnership template as shown in FIG. 5, lead users with system administration authority may configure the partnership template with business rules that will facilitate project creation in the fashion desired. This begins with establishing default values for project attributes that are to be tracked, including, but not limited to:

Project contacts (customer and vendor users responsible for projects)

Global project attributes (based on those configured for the partnership, optional)

Maintenance users (users/groups allowed to maintain projects)

Notification users (users/groups to receive notification about projects)

Project file attachments (i.e. standard forms, optional)

Users will see global project attributes in their own company's nomenclature, as defined by their company and the respective specific partnership.

Lead users can then establish default values for each project activity on the partnership template, including, but not limited to:

Responsible user (user typically responsible for project activity)

Anchor activity (preceding project activity, if applicable)

+Days (approximately days for completion after anchor activity)

Workdays (days of the week worked)

Advanced notification days (days to be notified before planned completion date if open, optional)

third party organization (if project activity is to be outsourced, optional)

third party user (if project activity is to be outsourced, optional)

Maintenance users (users/groups allowed to maintain project activity)

Notification users (users/groups to receive notification about project activity)

Activity file attachments (optional)

Users will see each project activity name in their own company's nomenclature, as defined by their company.

Organizations may have as many partnership templates as desired to account for the different types of projects between organizations. This is very useful as different types of projects require different project activities and often have different project and project activity attributes.

It is important to note that once a project is created using a partnership template, no connection is maintained to that partnership template, since there is no guarantee that the partnership template will always contain the same information it did when the project was originally created. Partnership templates are only intended to save time in creating projects and are therefore of no consequence to a project after that project is created.

Each customer and vendor organization has lead users that can create projects. Only lead users will have this opportunity. Creating projects in the system is a 3-step process:

Step 1: Select Partner and Partnership Template

The first step in creating a project is to select a partner as shown in FIG. 6. Lead customer users are asked to select a vendor. Lead vendor users are asked to select a customer. Only those organizations that have a partnership with the user's organization will be shown. Once a partner is selected, the user will then be asked to select a partnership template that will be used to create the project. Only those partnership templates with the chosen partner will be shown.

Step 2: Select/Enter Basic Project Information

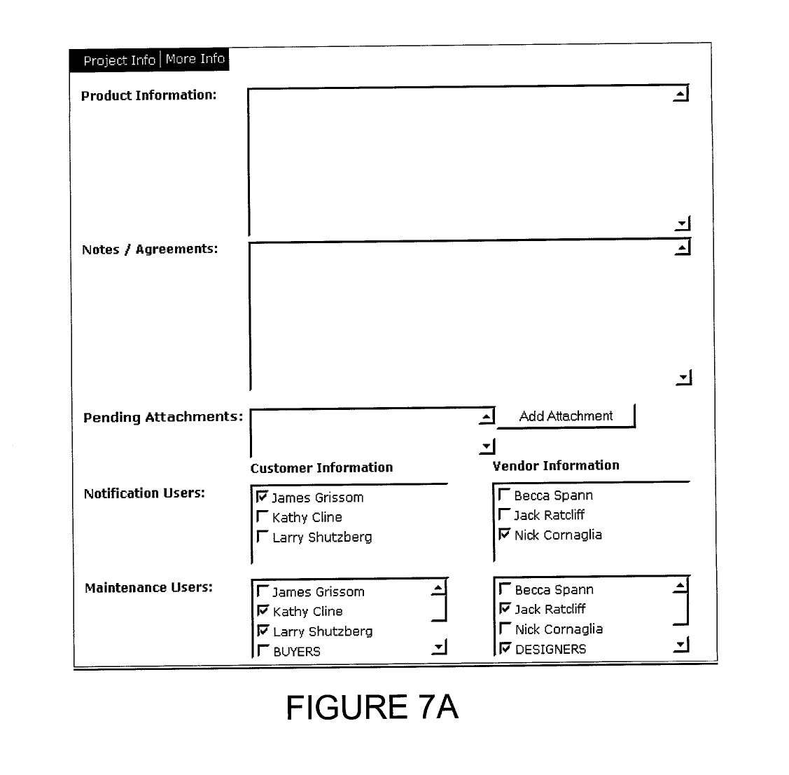

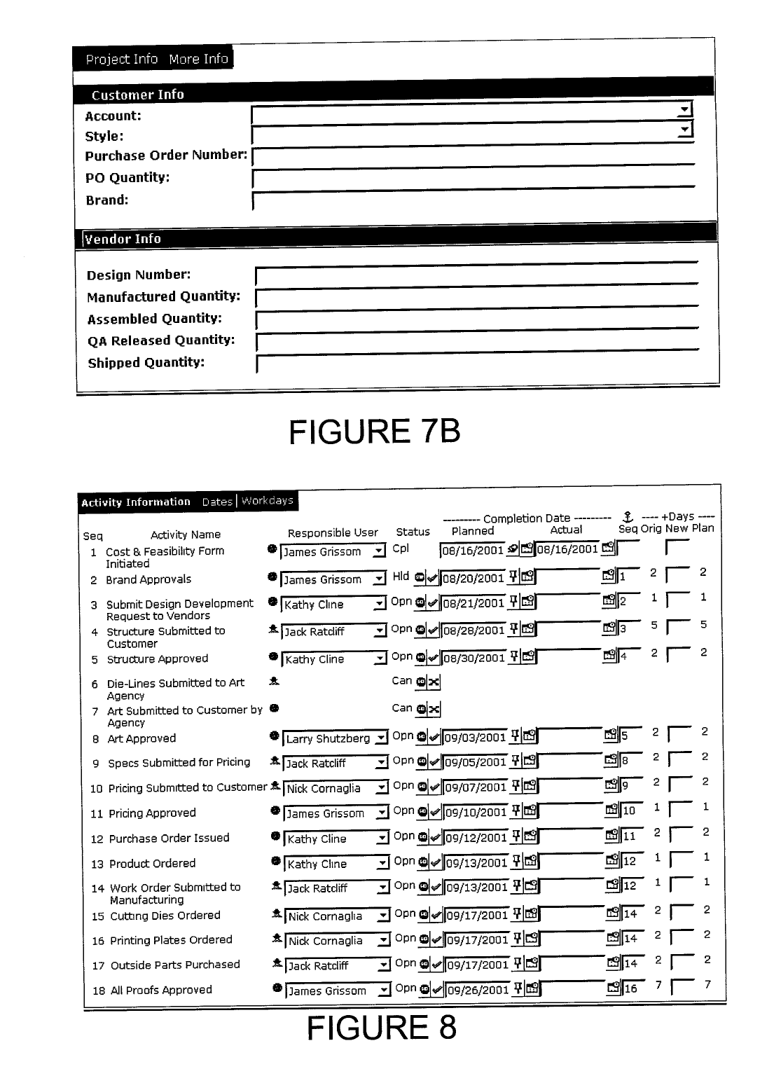

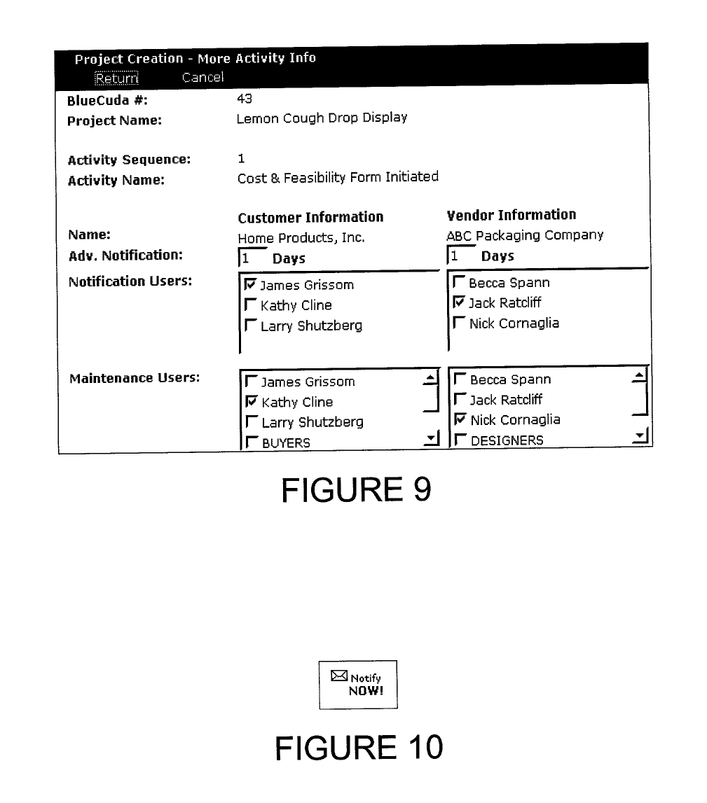

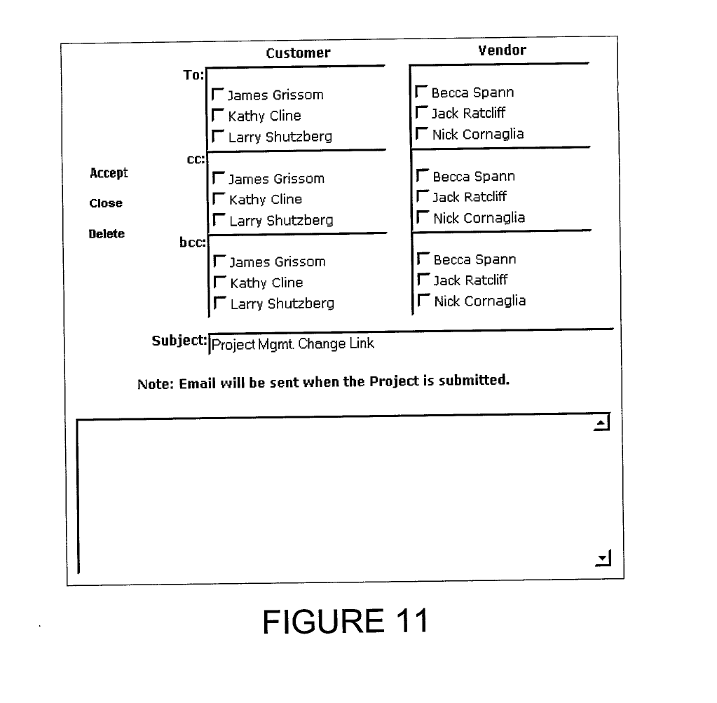

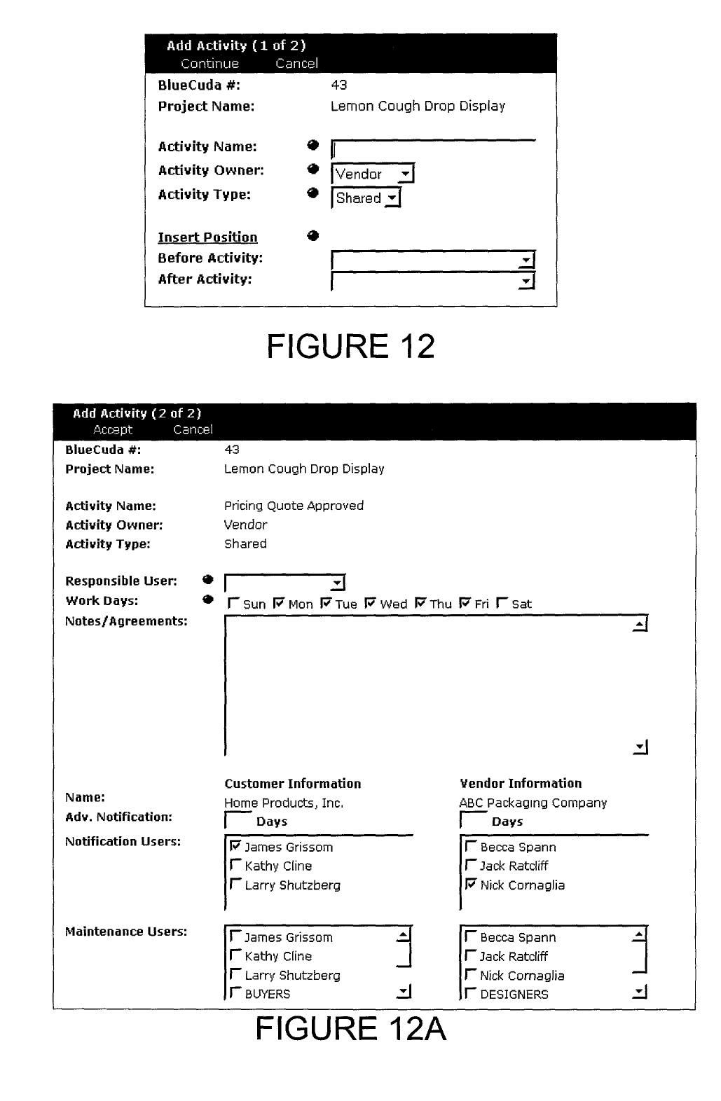

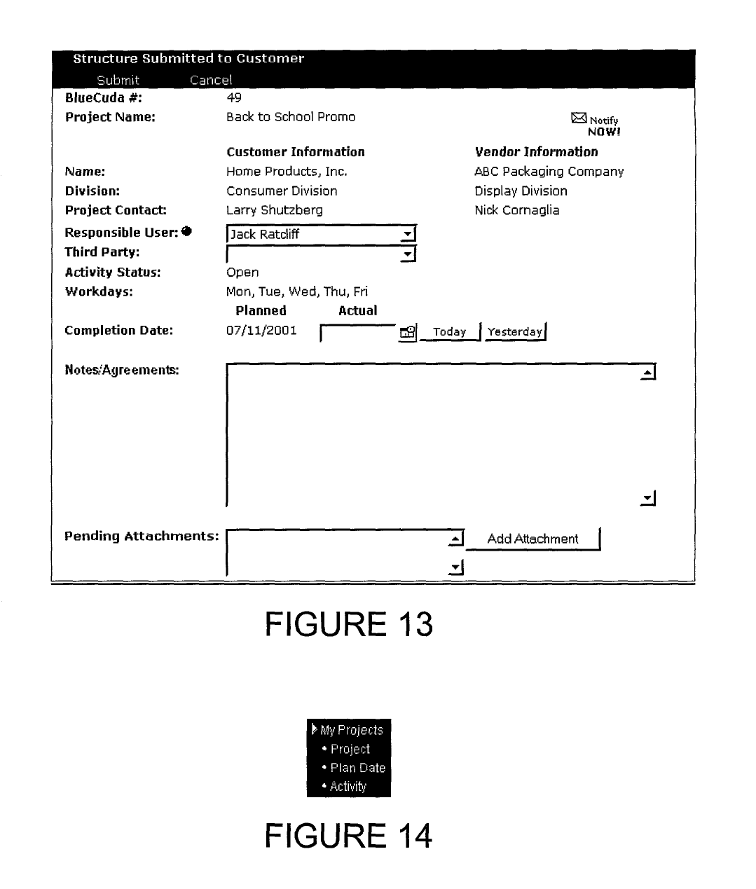

Once a partner and partnership template is selected, users will be asked to enter basic project information. Many of these values will be defaulted from the partnership template selected. In addition to entering basic project information as shown in FIG. 7, users will be asked to select or enter global project attributes as defined by the customer and vendor organizations, as well as for the specific partnership involved. Users will also be given a chance to change the partnership template defaults for customer and vendor notification and maintenance users for the project being created. Users may also optionally attach any project files to the project being created.

Step 3: Establish Project Activities and Timeline

After basic project information is entered, users are asked to establish project activities as well as attributes associated with each project activity, including, but not limited to, responsible user and planned completion date for each activity as shown in FIG. 8. Project activities and related attributes are set by default from the partnership template selected but can be altered for the project being created.

Users have several options for establishing planned completion dates for each project activity. Critical planned completion dates may be established for certain project activities and the system can calculate planned completion dates for all remaining project activities. Alternatively, users may enter all dates manually. Likewise, users may let the system calculate certain dates, override certain calculated dates, and recalculate other dates based on these overrides. Planned completion date recalculation for project activities can take place at any time during the life of the project.

Users also have the option of canceling certain project activities that will not be needed to be completed on the project (or uncanceling previously canceled project activities). Likewise, users may add special project activities that were not defined on the partnership template but are needed for the project being created. Project activities may be added or canceled at any time during the life of the project. Users are also given the option of placing certain project activities on hold or releasing previously held project activities. To facilitate project cancellation, users may select an option to cancel all open project activities. Similarly, users may uncancel all previously canceled project activities, hold all open project activities, or release all held project activities.

To facilitate flexible scheduling, users have the option of altering the normal workdays for any project activity. This enables compression with respect to planned completion date calculations. Users may also alter the default settings for customer and vendor notification and maintenance users for any project activity or attach desired files to any project activity. Additionally, users may assign any project activity to a third party.

To facilitate quicker data entry, all date fields have calendar buttons. Likewise, a button to “Pin” or “Unpin” a planned completion date is available for each project activity.

Users also have a “Notify Now” option, shown in FIG. 10, that will notify other users by email immediately of the project being created. Alternatively, appropriate users will be notified of the new project when they receive the next system newsletter by email.

Since many decisions are made when creating or maintaining a project, the system provides users with a “reset” option that resets all project activities back to their original state. When creating a project, the original state is the state when all project activities were set by default from the partnership template selected. Accordingly, any added project activities would be lost and all project activity values would be reset to their original template values. When maintaining an existing project, the original state is the state before maintenance began.

Once a project has been created, it can be maintained at any time. Only users with maintenance authority for an existing project can maintain that project. Users indicated as project contacts on a project are automatically granted maintenance authority for that project. Alternatively, users must be specified as a maintenance user for a project or be a member of a group that is specified as a maintenance user for a project to maintain that project.

Once users access a project for maintenance, all system functions are identical to those found during project creation. The only exception is that users are not required to select a partner and partnership template since the project was already created.

It is also important to note that only planned completion dates are considered during the date recalculation process. Accordingly, as certain project activities are completed ahead of or behind schedule, downstream project activities may not be automatically recalculated.

Once project activities are defined and critical/desired completion dates are established for at least one shared project activity, the system uses “smart” logic to calculate planned completion dates for all remaining project activities. The date calculations are performed by anchoring the project activities. Using these activity anchors, the system can calculate backwards or forwards in determining planned completion dates for all remaining project activities. During date calculations, the system skips any project activity with a predetermined planned completion date (or “pinned” date). The system uses activity workdays, holidays, activity anchors, and +days to determine planned completion dates for all “unpinned” project activities. If more than one project activity is anchored to another project activity, the system determines an appropriate date that respects all anchored activities. If certain activities for a given project take more or less days than normal, users can override the +days for those project activities, which facilitates more accurate date calculations. As planned completion dates are entered (“pinned”), users are warned when these dates fall on a non-workday or holiday. They are also warned when planned or actual completion dates fall in the past or when activity +days are shorter than usual. Authorized users may revisit any project to change and recalculate planned completion dates during the life of that project.

Since all non-Canceled project activities (except the first) must be anchored to another non-Canceled project activity, and the first one is Shared, and Shared project activities cannot be anchored to Private project activities, the first non-Canceled project activity will always be a Shared activity. This prevents one side from seeing a Shared project activity anchored to a Private project activity it can't see. Based on these business rules, the end result for all non-Canceled activities displayed on a project will be a single activity on top (Open, Held, or Completed) with one or more branches of downstream anchored activities below. Some project activities will be anchored to each other following a single downstream branch while other project activities will have multiple branches of downstream anchored activities. Canceled project activities can fall anywhere and may or may not be anchored. The business rules above prevent the possibility of circular anchoring of project activities (infinite looping). Likewise, since project activities can only have a single anchor, anchor branches can never come together downstream.

Private activities on the other side represent hidden branches to the anchor tree with all Private activities ultimately anchored upstream to a viewable Shared activity (somewhere upstream). If a Shared activity is canceled and that activity has a hidden anchored branch of Private activities, and if all of those hidden Private activities are non-Completed, they will become Canceled as well. If any of those hidden Private activities are Completed, those hidden Private activities will remain unchanged and therefore will be orphaned. The newsletter will inform users of changes made to projects that create orphaned hidden Private activities. The other side will then have to perform Project Maintenance to fix the orphaned activity problem.

The system uses the following concepts to perform date calculations:

Based on the previous business rules, if any project activities are non-Canceled, at least one Shared project activity will have its planned completion date pinned.

Canceled project activities will not affect planned completion date calculations.

Using a pinned planned completion date, date calculations can occur upstream or downstream. That is to say, planned completion dates can be calculated for all downstream project activities following the anchor path from a pinned project activity or, dates can be calculated for all upstream project activities following the anchor path from a pinned project activity.

When calculating upstream, the planned completion date from a Private project activity cannot be used to calculate the planned completion date for a Shared project activity. Accordingly, planned completion dates for Private project activities will be ignored when calculating planned completion dates for upstream Shared project activities.

This upstream and downstream planned completion date calculation concept presents the following issues:

ISSUE 1: More than one planned completion date can be pinned in a single path of anchored activities. For example, planned completion dates can be pinned for the first and last project activities in a single path of anchored activities. Therefore, a decision must be made whether to calculate forward (downstream) from the first project activity or backward (upstream) from the last project activity.

RESOLUTION 1: When given a choice of calculating downstream or upstream, the system will always calculate upstream. This provides greater assurance that upstream project activities are completed on time.

ISSUE 2: More than one planned completion date can be pinned on multiple paths of anchored activities, which ultimately converge upstream into a single path of anchored activities. Therefore, a decision must be made as to which path of anchored activities (and corresponding planned completion date calculations) takes priority once multiple anchor paths converge upstream into a single anchor path.

RESOLUTION 2: When given a choice of multiple upstream planned completion date calculations, always choose the one that creates the earliest planned completion date. This provides greater assurance that upstream project activities are completed on time.

ISSUE 3: Non-Canceled Private project activities on the other side (not viewable) can ultimately anchor upstream to a Shared project activity (which is viewable). Therefore a decision must be made reflecting what, if anything, should be done to planned completion dates for non-Canceled Private project activities on the other side (hidden) when the planned completion date changes for an upstream Shared project activity or when an upstream Shared project activity is Canceled.

RESOLUTION 3: For each non-Canceled Private project activity on the other side (hidden), the upstream anchor path eventually leads to a viewable Shared project activity. This leaves five possibilities:

If the upstream Shared project activity is originally Canceled and remains Canceled:

For all downstream Private project activities on the other side:

No planned completion date recalculation is required.

If the upstream Shared project activity is originally non-Canceled and remains non-Canceled, and the planned completion date for this activity has not changed:

For all downstream Private project activities on the other side:

No planned completion date recalculation is required.

If the upstream Shared project activity is originally non-Canceled and remains non-Canceled, and the planned completion date for this activity has changed:

For all downstream Private project activities on the other side that are non-Canceled:

A new planned completion date will be recalculated using downstream calculation logic.

For all downstream Private project activities on the other side that are Canceled:

No planned completion date recalculation is required.

If the upstream Shared project activity is not originally Canceled but becomes Canceled:

For all downstream Private project activities on the other side that are non-Completed and non-Canceled:

No planned completion date recalculation is required.

For all downstream Private activities on the other side that are Completed:

No planned completion date recalculation is required though the system will track that a Private project activity has been “orphaned” (i.e. is no longer anchored to other project activities).

For all downstream Private project activities on the other side that are Canceled:

No planned completion date recalculation is required.

If the upstream Shared project activity is originally Canceled but becomes non-Canceled:

For all downstream Private project activities on the other side:

No planned completion date recalculation is required though the system will determine if previously orphaned Private project activities are still orphaned.

Though the system does Cancel all downstream Private project activities on the other side when an upstream Shared project activity is Canceled, it will not Uncancel all downstream Private project activities on the other side when an upstream Shared project activity is Uncanceled. Users on the other side will have to determine for themselves whether or not to Uncancel their Private project activities. The newsletter will inform them that an upstream Shared project activity was Uncanceled.

Since orphaned activities are possible, they will be shown on the emailed newsletter to system users, allowing the other side to perform project maintenance to fix an orphaned activity problem.

Once a project has been created, activities on that project can be maintained at any time. Only users with maintenance authority for an existing project activity can maintain that activity. Users indicated as responsible users for a project activity are automatically granted maintenance authority for that activity. Likewise, users with maintenance authority on a project are automatically granted maintenance authority for all activities on that project. Alternatively, users must be specified as a maintenance user for a project activity or be a member of a group that is specified as a maintenance user for a project activity to maintain that activity.

Authorized users can maintain any activity simply by selecting that activity. Once an activity is selected for maintenance, users may change certain activity information, enter an actual completion date, or attach a file to the activity. Users cannot change the planned completion date for an activity as this can only be done during project creation or project maintenance, and only by users authorized to make schedule changes for that project. Similarly, users cannot directly change the status of an activity but can only do so by entering or removing an actual completion date. The system incorporates “Yesterday,” “Today,” and calendar buttons that can be used to quickly enter an actual completion date.

Users have a “Notify Now” option that will notify other users immediately of the activity being changed. Alternatively, appropriate users will be notified of the changed activity when they are sent the next system newsletter by email.

Users can also take advantage of a “Quick Updating” feature. This feature allows users to quickly enter an actual completion date and/or quickly attach files to activities that are on projects for which they have maintenance privileges or project activities that have been assigned to them (they are the responsible user). “Yesterday,” “Today,” and calendar buttons are also available with this feature to facilitate quick data entry.

Third party users assigned to an activity can retrieve and store activity documents as well as maintain activity notes. Third party users have no visibility to global project information and cannot affect the status of a project activity.

The system has several views that allow users to view both projects and project activities. Users may select a variety of “MY VIEWS”, which show users only their projects or project activities assigned to them or “COMPANY VIEWS”, which show all company projects or project activities for a given organization.

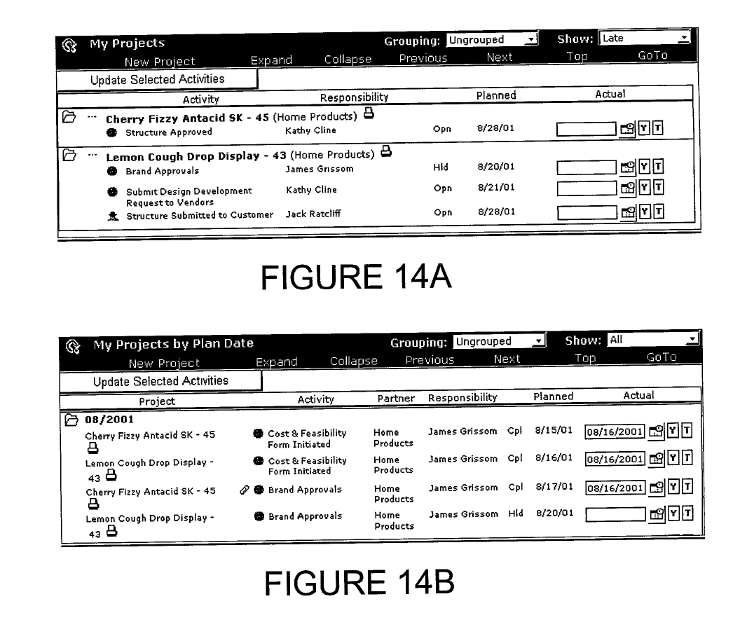

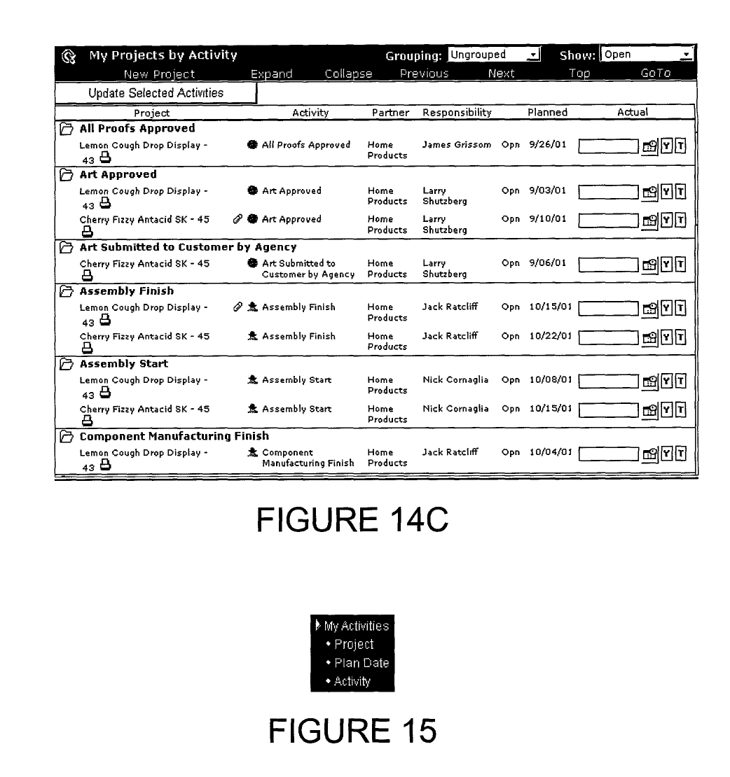

There are two types of MY VIEWS: MY PROJECTS and MY ACTIVITIES. MY PROJECTS, shown in FIGS. 14, 14A, 14B, 14C gives users the ability to view only those projects where the user is the Project Contact. This gives users the ability to view and manage just their projects and related activities versus projects and related activities for their entire company. Users can view projects and related activities for MY PROJECTS in order by project name/activity sequence or they can view project activities across all projects for MY PROJECTS in order by planned completion date or by activity name/planned completion date. All of the MY PROJECTS views have a “Quick Update” function, which allow users to view and quickly update all activities for their projects without having to open each individual activity.

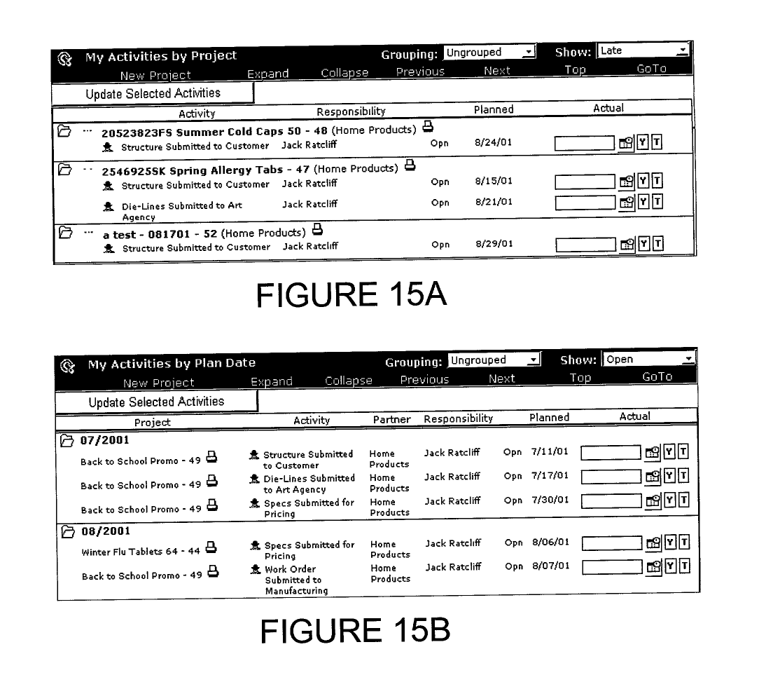

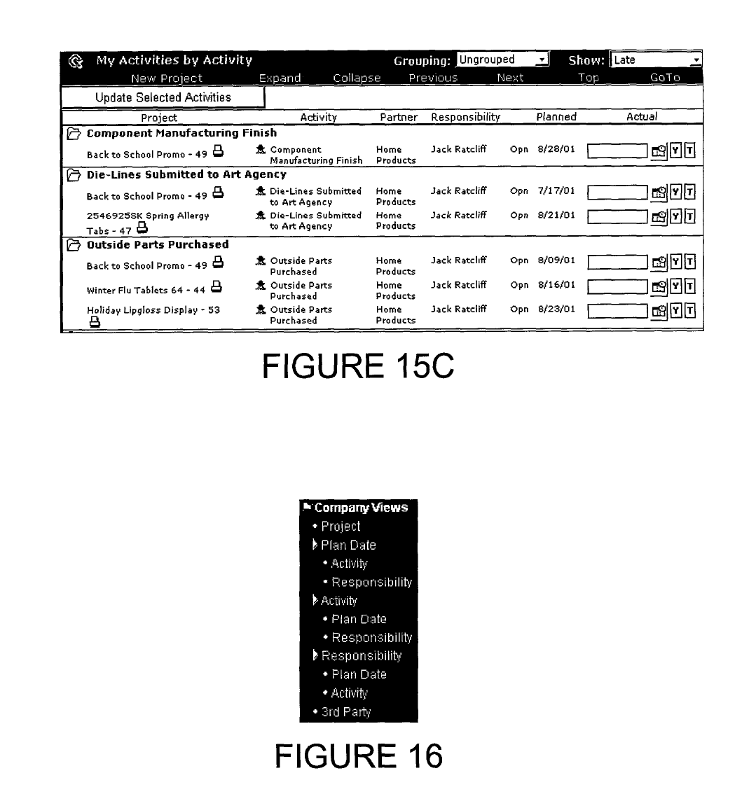

MY ACTIVITIES, shown in FIGS. 15, 15A, 15B, 15C give users the ability to view only those project activities that have been assigned to them (for which they are the responsible user). This gives users the ability to view and manage just their project activities versus project activities for their entire company. Users can view projects and related activities for MY ACTIVITIES in order by project name/activity sequence or they can view project activities across all projects for MY ACTIVITIES in order by planned completion date or by activity name/planned completion date. All of the MY ACTIVITIES views have a “Quick Update” function, which allow users to view and quickly update all activities for which they are responsible without having to open each individual activity.

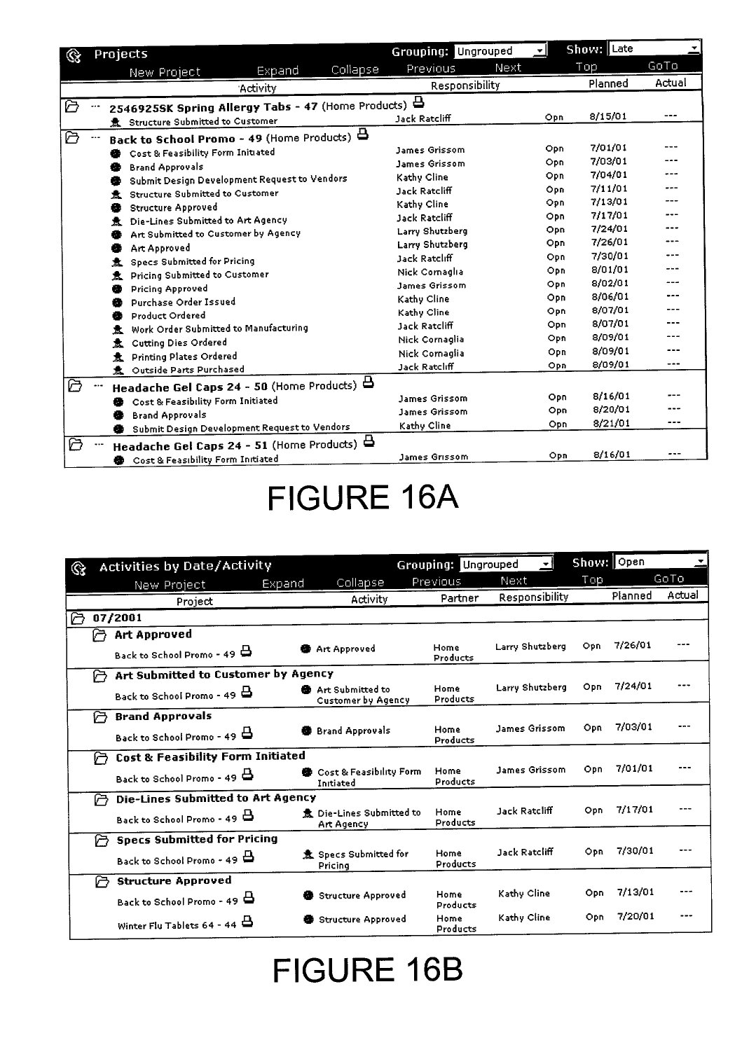

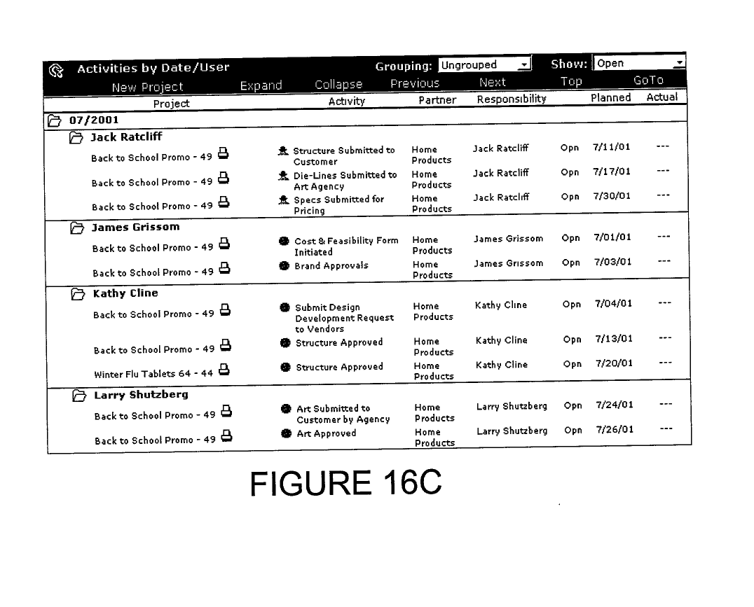

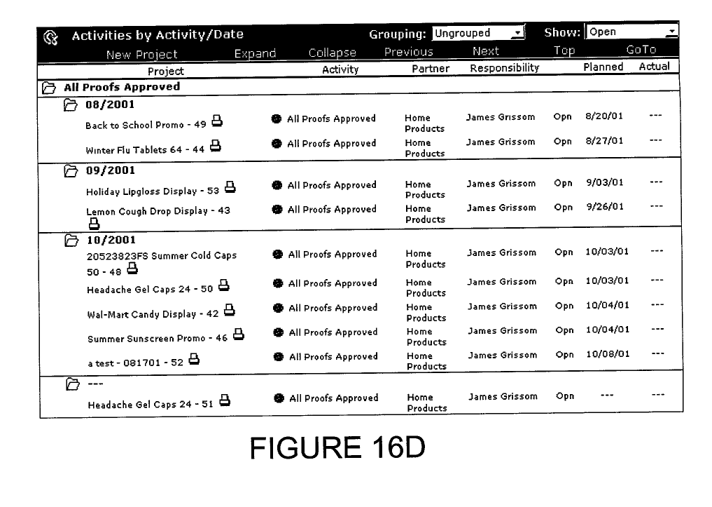

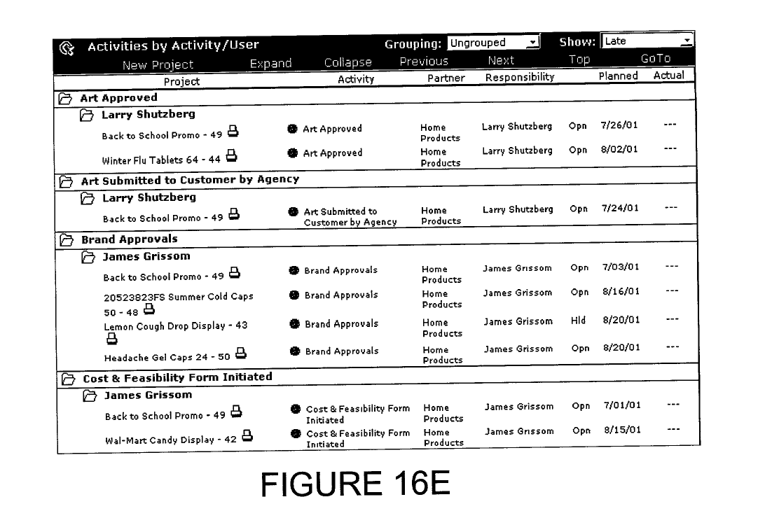

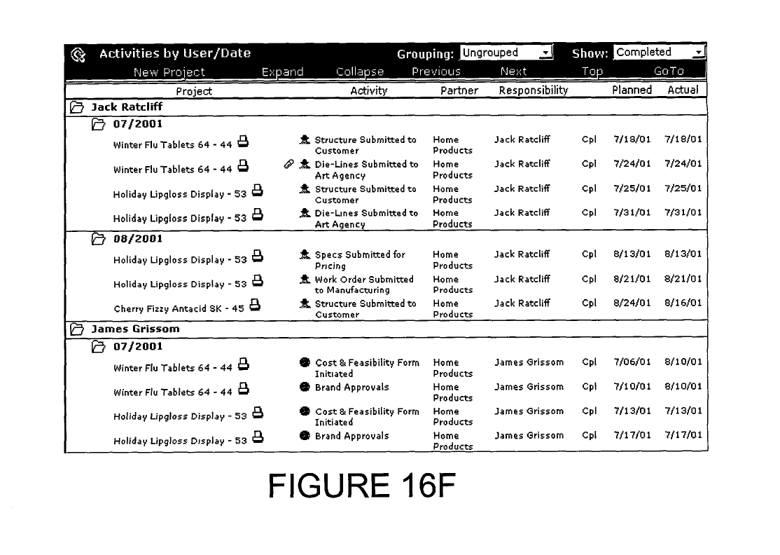

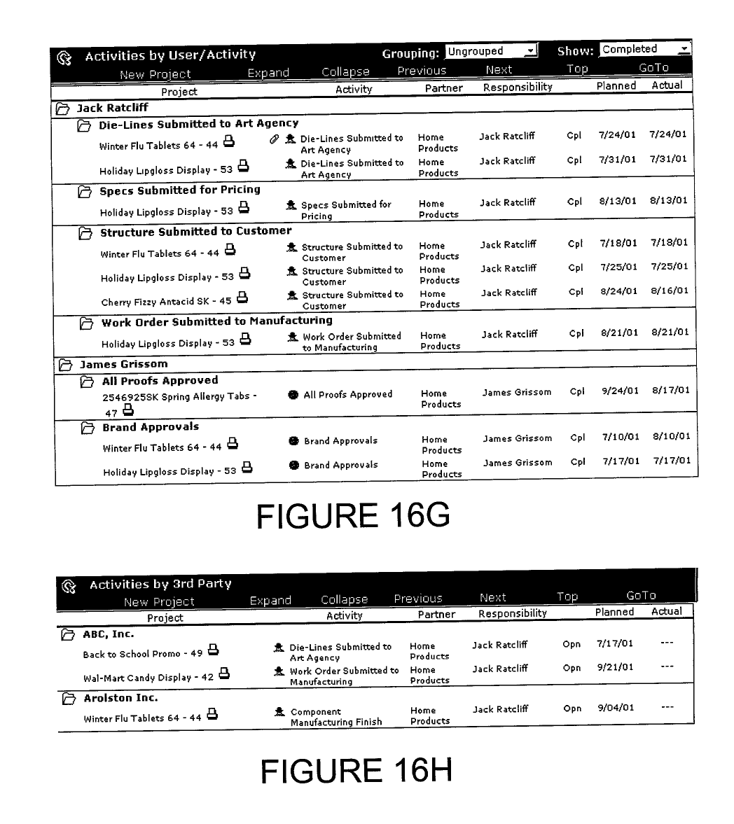

Five types of COMPANY VIEWS are provided as shown in FIGS. 16, 16A, 16B, 16C, 16D, 16E, 16F, 16G, 16H: Project, Planned Date, Activity, Responsibility, and Third Party. Each of these views gives users the ability to see all company projects and related activities in a certain order. Project shows projects and related activities by project name/activity sequence. Planned Date shows project activities across all projects by planned completion date/activity name or by planned completion date/responsible user. Activity shows project activities across all projects by activity name/planned completion date or by activity name/responsible user. Responsibility shows project activities across all projects by responsible user/planned completion date or by responsible user/activity name. Third Party shows project activities assigned to Third parties across all projects by Third party/planned completion date.

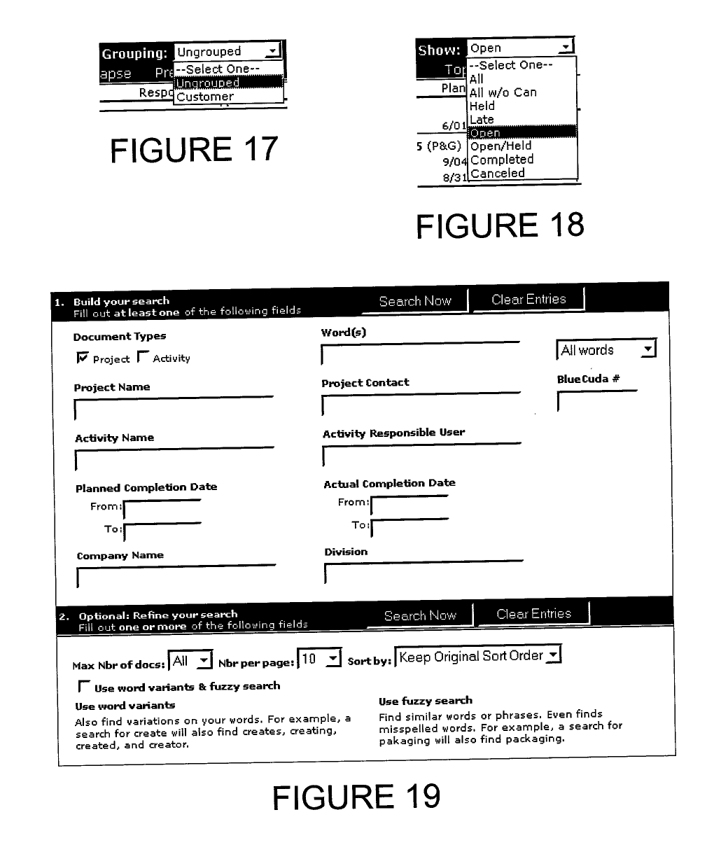

Each view offers view options for users, as shown in FIGS. 17 and 18. First, for all views except the third party view, users have the option of viewing projects and related activities grouped by their partner (customer or vendor). Second, for all views, users have the option of viewing only those project activities with certain activity statuses or only those project activities that are late.

The system provides comprehensive searching that allows users to find projects, project activities, and file attachments easily. Several searching filters are provided, as shown in FIG. 19, to help the user determine what they would like to see. The system searches projects, project activities, or both, as well as all files attached to projects and/or project activities. The system also allows for recursive searching, which lets users continuously search the results of their previous search.

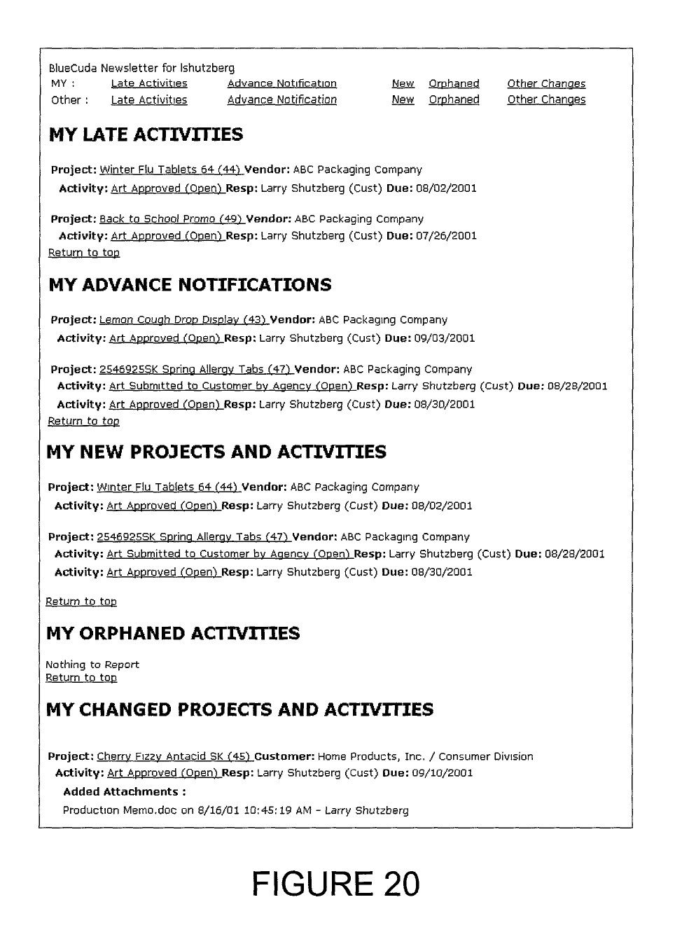

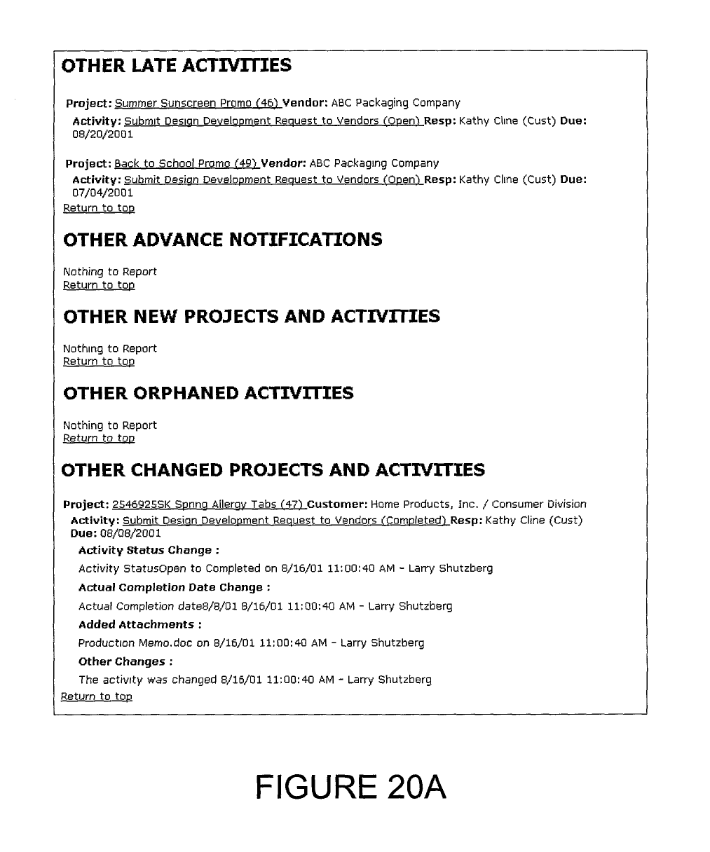

The system incorporates email notification. However, unlike typical email notification functionality, the system encapsulates and organizes all notifications into an easy-to-understand, personalized newsletter, as shown in FIGS. 20, 20A. The system has three modes of email notification: NOTIFY NOW, SYSTEM-WIDE NEWSLETTER, and INSTANT NEWSLETTER.

Notify Now—This mode is triggered when “Notify Now” is selected during project creation, project maintenance, or activity maintenance. Selecting this option will initiate an email to selected users with selected information pertaining to what was just created or changed (including any special note/text that was entered when “Notify Now” was selected). This is the only form of email in the system that can include non-system users. All emails include hot-links into projects and/or project activities that are included in the email (except for non-system users). Immediately following the creation or change of a project or project activity, these emails will be sent.

System-Wide Newslettering—This mode is triggered daily based on pre-configured time settings. When initiated, the system searches through all projects and project activities in search of any changes since the last System-Wide Newslettering took place. The system also searches for certain business rules requiring user notification (i.e. lateness, advanced notification). Any changes and notifications found are then compiled into a single email for each system user. The newsletter includes details about each change, including who made the change, what date and time the change was made, and from/to values where appropriate. All emails include hot-links into projects and/or project activities that are included in the email. Once this function is completed, the system stores the date and time as a cutoff for determining new changes when System-Wide Newslettering is run again.

Instant Newsletter—This mode is triggered by the user. It functions similar to the System-Wide Newslettering with the following exceptions:

The system generates a view instead of an email and only for the user that triggered the function. Once this view is generated, the user has the option to print the view.

The user selects an “As Of Date” which generates a newsletter for all changes back to that date.

The system does not store date and time as a cutoff for capturing new changes. Accordingly, the user may see some of the same information on the next system-wide newsletter, along with any additional changes or notifications that arise.

Emailed newsletters contain groupings, including Late Activities, Advanced Notifications, New and Changes Projects/Activities, and Changed Projects/Activities. Additionally, users see these groups first for MY PROJECTS/MY ACTIVITIES and second for COMPANY PROJECTS/COMPANY ACTIVITIES.

Users can configure how they would like to see their newsletters and which type of projects and related activities they would like to see on their newsletter.

The system offers users the option of downloading all project and related activity information for their company. This gives each company the ability to extract system information for their company as a means to have an internal backup as well as a way for companies to extend the functions and features of the system within their own organization.

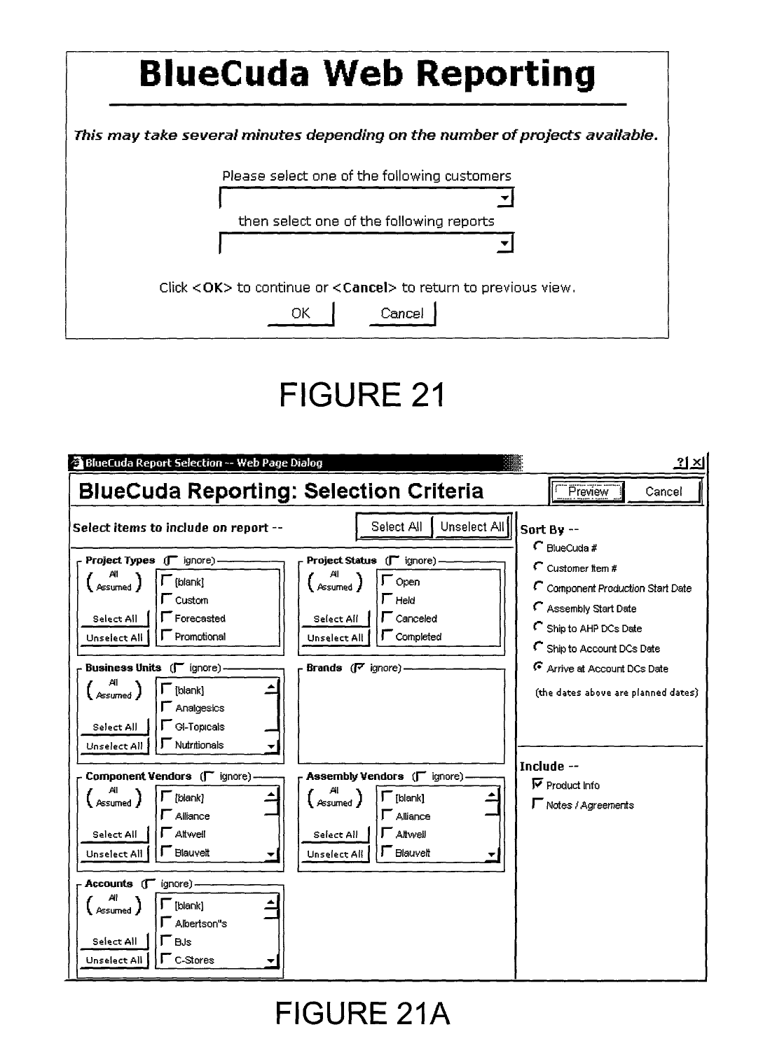

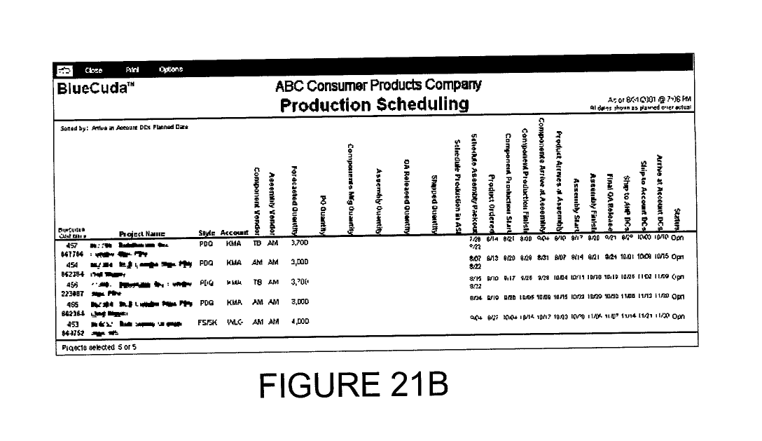

As shown in FIG. 21, 21A, 21B, the system offers configurable web-based reporting whereby each organization can customize the method, format and delivery timetable for project status reporting. Incorporated into this feature is the ability for organizations to use their global project attributes as sort and filter criteria for these reports.

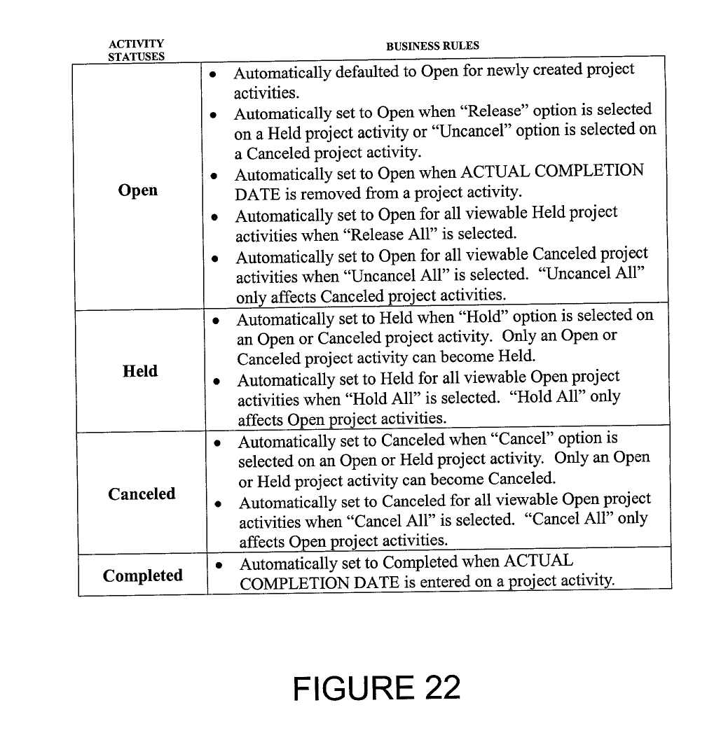

Each project has one or more project activities. Each activity on a project has an ACTIVITY STATUS as shown in FIG. 22.

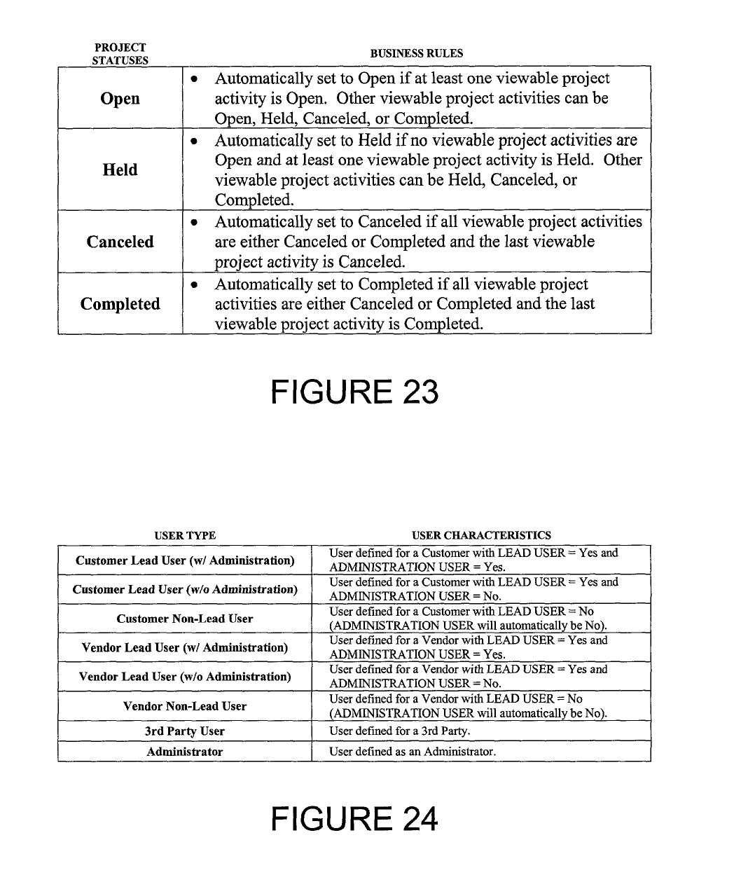

Each Project has two PROJECT STATUSES, one for the Customer and one for the Vendor. PROJECT STATUSES are determined automatically using the business rules below, applied only to the project activities that each side can see (Customer and Vendor). PROJECT STATUSES are shown in FIG. 23.

Either the Customer or Vendor owns each project activity. Project activities can be Shared (viewable by both the Customer and Vendor) or Private (viewable by only the project activity owner). 3rd Party Users can only view project activities assigned to their company, Shared and Private. The system administrator can view all project activities throughout the system, Shared and Private, for all Customers and Vendors.

The system will have the types of users shown in FIG. 24.

The only difference between lead users and non-lead users is that only lead users can create projects. Additionally, only lead users w/administration can view and maintain defaults for their company, including their company's master activity list and partnership templates.

Third party users can enter the system and view all activities throughout the system that were assigned to their company, for all customers and vendors. Additionally, 3^{rd} party users can edit file attachments on activities that were assigned to them.

Administrators can perform all system functions, including several administrator-only functions.

1. A system for managing a collaborative project involving a plurality of organizations, comprising:
a. at least one template for customized use by each of the organizations in defining activities related to the project;
i. the template adapted to receive a list of activities related to the project from each organization;
b. a database adapted to receive and store each organization's list of activities in organization specific nomenclature;
c. tracking functionality adapted to track the progress of the activities;
d. merging functionality adapted to cross reference related activities between the organizations using the organization specific nomenclature allowing the organizations to share information regarding project activities; and
e. presentation/interaction functionality adapted to permit each organization to view and access shared information related to project activities in each organization's specific nomenclature.

2. The system as set forth in claim 1 wherein the system is adapted to allow each of the organizations to manage a plurality of projects.

3. The system as set forth in claim 1 wherein the system is adapted to allow the organizations to select a pre-existing template for a new project.

4. The system as set forth in claim 1 wherein the presentation/interaction functionality is adapted to permit the organizations to input target completion dates for the activities.

5. The system as set forth in claim 4 further comprising processing functionality adapted to calculate the target completion dates for the activities.

6. The system as set forth in claim 2 wherein the presentation/interaction functionality is adapted to allow each organization to input a list of users, each user on the list of users capable of accessing the database for the project.

7. The system as set forth in claim 6 further comprising a notification functionality adapted to send email messages to each of the users.

8. The system as set forth in claim 7 wherein the processing functionality is adapted to cooperate with the notification functionality to combine the messages into a newsletter for sending to the users.

9. The system as set forth in claim 7 wherein the notification functionality is adapted to allow each user to send email messages to any other user.

10. The system as set forth in claim 1 wherein the presentation/interaction functionality is adapted to allow each organization to input business rules related to the project.

11. The system as set forth in claim 10 wherein the business rules comprise security information, notification rules, standard forms, and default values.

12. The system as set forth in claim 6 further comprising a security functionality adapted to allow organizations to deny at least one user access to information related to at least one activity.

13. The system as set forth in claim 12 wherein the system is adapted for use by third parties to assist the organizations in completing activities.

14. The system as set forth in claim 13 wherein the database is adapted to receive and store a third party list of activities.

15. The system as set forth in claim 7 wherein the processing functionality is adapted to cooperate with the notification functionality and the merging functionality to provide reporting to each organization of project information in each organization's specific nomenclature.

16. The system as set forth in claim 7 wherein the processing functionality is adapted to cooperate with the notification functionality and the merging functionality to provide visibility and accessibility to each organization of related activities in a plurality of projects.

17. A system for managing a collaborative project involving a plurality of organizations, comprising:
a. a template for customized use by each of the organizations in defining activities related to the project;
i. the template adapted to receive a list of activities related to the project from each organization;
b. a database adapted to receive and store each organization's list of activities in organization specific nomenclature;
c. tracking means for tracking the progress of the activities;
d. merging means for cross referencing related activities between the organizations using the organization specific nomenclature allowing the organizations to share information regarding project activities; and
e. presentation/interaction means for permitting each organization to view and access shared information related to the project activities in each organization's specific nomenclature.

18. The system as set forth in claim 17 wherein the system allows each organizations to manage a plurality of projects.

19. The system as set forth in claim 17 wherein the system allows the organizations to select a pre-existing template for a new project.

20. The system as set forth in claim 17 wherein the presentation/interaction means permits the organizations to input target completion dates for the activities.

21. The system as set forth in claim 20 further comprising processing means for calculating the target completion dates for the activities.

22. The system as set forth in claim 18 wherein the presentation/interaction means allows each organization to input a list of users, each user on the list of users capable of accessing the database for the project.

23. The system as set forth in claim 22 further comprising a notification means for sending email messages to each of the users.

24. The system as set forth in claim 23 wherein the processing means cooperates with the notification means to combine the messages into a newsletter for sending to the users.

25. The system as set forth in claim 23 wherein the notification means allows each user to send email messages to any other user.

26. The system as set forth in claim 17 wherein the presentation/interaction means allows each organization to input business rules related to the project.

27. The system as set forth in claim 26 wherein the business rules comprise security information, notification rules, standard forms, and default values.

28. The system as set forth in claim 22 further comprising a security means for allowing organizations to determine which users are granted access to information related to the activities.

29. The system as set forth in claim 28 wherein the system is adapted for use by third parties to assist the organizations in completing activities.

30. The system s set forth in claim 29 wherein the database is adapted to receive a third party list of activities.

31. The system as set forth in claim 23, wherein the processing means is adapted to cooperate with the notification means and the merging means to provide reporting to each organization of project information in each organization's specific nomenclature.

32. The system as set forth in claim 23, wherein the processing means is adapted to cooperate with the notification means and the merging means to provide visibility and accessibility to each organization of related activities in a plurality of projects.

33. A system for managing collaborative projects involving a plurality of organizations, comprising:
a. a template for customized use by each of the organizations in defining activities related to a project;
i. the template adapted to receive a list of activities related to the project from each organization;
b. a database adapted to receive and store each organization's list of activities in organization specific nomenclature;
c. tracking functionality adapted to track the progress of the activities;
d. merging functionality adapted to cross reference related activities between the organizations using the organization specific nomenclature allowing the organizations to share information regarding project activities;
e. presentation/interaction functionality adapted to permit each organization to view and access shared information related to project activities in each organization's specific nomenclature; and
f. processing functionality adapted to calculate target completion dates for the activities.

34. The system as set forth in claim 33 wherein the presentation/interaction functionality is adapted to cooperate with the processing functionality to allow input of the target completion date for at least one activity and calculation of the target completion dates for the remaining activities.

35. The system as set forth in claim 33 wherein the system is adapted to allow each of the organizations to access a plurality of templates to initiate and manage a plurality of projects.

36. The system as set forth in claim 33 wherein the system is adapted to allow the organizations to select a pre-existing template for a new project.

37. The system as set forth in claim 34 wherein the presentation/interaction functionality is adapted to allow each organization to input a list of users, each user on the list of users capable of accessing the database for the project.

38. The system as set forth in claim 37 further comprising a notification functionality adapted to send email messages to each of the users.

39. The system as set forth in claim 38 wherein the processing functionality is adapted to cooperate with the notification functionality to combine individual messages into a newsletter prior to sending to the users.

40. The system as set forth in claim 38 wherein the notification functionality is adapted to allow each user to send email messages to other users.

41. The system as set forth in claim 33 wherein the presentation/interaction functionality is adapted to allow each organization to input business rules related to the project, the business rules stored in the database.

42. The system as set forth in claim 41 wherein the business rules comprise security information.

43. The system as set forth in claim 41 wherein the business rules comprise notification rules.

44. The system as set forth in claim 41 wherein the business rules comprise standard forms.

45. The system as set forth in claim 41 wherein the business rules comprise default values.

46. The system as set forth in claim 37 further comprising a security functionality adapted to allow organizations to deny user access to information related to the activities.

47. The system as set forth in claim 46 wherein the system is adapted for use by third parties to assist the organizations in completing activities.

48. The system as set forth in claim 47 wherein the database is adapted to receive and store a third party list of activities.

49. The system as set forth in claim 37 further comprising searching functionality adapted to allow users to enter a search query in order to access information stored within the system.

50. The system as set forth in claim 49 wherein the searching functionality allows users to search documents stored in the database.

51. The system as set forth in claim 38 wherein the processing functionality is adapted to cooperate with the notification functionality and the merging functionality to provide reporting to each organization of project information in each organization's specific nomenclature.

52. The system as set forth in claim 38 wherein the processing functionality is adapted to cooperate with the notification functionality and the merging functionality to provide visibility and accessibility to each organization of related activities in a plurality of projects.

53. An automated method of managing a collaborative project involving a plurality of organizations, comprising:
a. providing a template for customized use by each of the organizations in defining activities related to the project;
i. the template adapted to receive a list of activities related to the project from each organization;
b. providing a database for receiving and storing each organization's list of activities in organization specific nomenclature;
c. tracking the progress of the activities;
d. cross referencing related activities between the organizations using the organization specific nomenclature allowing the organizations to share information regarding project activities; and
e. permitting each organization to view and access shared information related to project activities in each organization's specific nomenclature.

54. The method as set forth in claim 53 wherein the step of providing a template comprises allowing organizations to select a pre-existing template for a new project.

55. The method as set forth in claim 53 further comprising permitting the organizations to input target completion dates for the activities.

56. The method as set forth in claim 55 further comprising calculating the target completion dates for the activities.

57. The method as set forth in claim 53 further comprising allowing each organization to input a list of users for storage in the database, each user on the list of users capable of accessing the database of the project.

58. The method as set forth in claim 57 further comprising notifying users using email messages.

59. The method as set forth in claim 58 further comprising combining the email messages into a newsletter for sending to the users.

60. The method as set forth in claim 58 further comprising allowing each user to send email messages to any other user.

61. The method as set forth in claim 53 further comprising each organization inputting business rules related to the project, the business rules stored in the database.

62. The method as set forth in claim 53 further comprising searching the database for information related to the project.

63. The method as set forth in claim 53 further comprising allowing each organization to manage a plurality of projects.

64. The method as set forth in claim 63 further comprising allowing each organization to view and access information relating to activities in a plurality of projects, the information provided in organization specific nomenclature.
